(19) United States
(12) Patent Application Publication
(10) Pub. No.: US 2026/0098986 A1
(43) Pub. Date: Apr. 9, 2026

(54) OPTICAL DEVICE AND LIGHT-SHIELDING FILM

(71) Applicant: CANON KABUSHIKI KAISHA, Tokyo (JP)

(72) Inventor: REIKO KUBOTA, Kanagawa (JP)

(21) Appl. No.: 19/341,340

(22) Filed: Sep. 26, 2025

(30) Foreign Application Priority Data
Oct. 3, 2024 (JP) 2024-174228

(51) Int. Cl. G02B 1/111; G02B 1/12; G02B 13/00; G02B 13/14

(52) U.S. Cl. CPC G02B 1/111; G02B 1/12; G02B 13/006; G02B 13/14

(57) ABSTRACT

Provided is an optical device including a first optical element, a second optical element, a third optical element, and a light-shielding film. The light-shielding film is a cured film of a photosensitive resin composition. The edge surface of the first optical element and/or the edge surface of the second optical element includes a chamfered portion formed in contact with an outer periphery of a cemented surface of the first optical element and/or the second optical element. A curing reaction rate of the photosensitive resin composition on a first surface of the light-shielding film in contact with the edge surface of the first optical element and the edge surface of the second optical element is lower than a curing reaction rate of the photosensitive resin composition on a second surface thereof on a side opposite to the first surface. The light-shielding film contains a compound having a thiol group.

### BACKGROUND

### Field of the Technology

The present disclosure relates to an optical device including a light-shielding film.

### Description of the Related Art

In an optical device to be used in optical equipment, a black light-shielding film is formed in an external region having an effective light beam diameter as required to reduce stray light.

The light-shielding film is a film to be formed mainly in an external region of glass that is a constituent member of the optical device. Here, the glass may be a lens or a prism. The glass may also be another optical glass or optical prism.

In Japanese Patent Laid-Open No. 2013-24988, there is disclosed a black light-shielding film containing a resin, inorganic particles, and organic particles, in which the film is harder at the air interface than the base material interface. In Japanese Patent Laid-Open No. 2011-170334, there is disclosed a black light-shielding film to be used in a wafer-level lens, which contains a photosensitive resin, a photopolymerization initiator, a colorant, inorganic fine particles, and a thiol.

The light-shielding film disclosed in Japanese Patent Laid-Open No. 2013-24988 does not contain a curing accelerator. As a result, when the thickness of the film is increased, it may become difficult to cure the film in a short period of time.

The lens disclosed in Japanese Patent Laid-Open No. 2011-170334 is formed directly on a base material and hence does not include a chamfered portion. The lens disclosed in Japanese Patent Laid-Open No. 2011-170334 does not include a cemented portion. As a result, when a large thermal shock is applied when lenses having different linear expansion coefficients are bonded to each other, strain may be caused in the lenses to degrade optical performance.

### SUMMARY

The present disclosure has been made in view of such related art, and is directed to the provision of an optical device excellent in productivity and environmental resistance, and a light-shielding film contributing to the optical device.

According to one aspect of the present disclosure, there is provided an optical device including: a first optical element; a second optical element; a third optical element configured to cement the first optical element and the second optical element together; and a light-shielding film continuously formed in contact with an edge surface of the first optical element, an edge surface of the second optical element, and an edge surface of the third optical element, wherein the light-shielding film is a cured film of a photosensitive resin composition, wherein the edge surface of the first optical element and/or the edge surface of the second optical element includes a chamfered portion formed in contact with an outer periphery of a cemented surface of the first optical element and/or the second optical element, wherein a curing reaction rate of the photosensitive resin composition on a first surface of the light-shielding film in contact with the edge surface of the first optical element and the edge surface of the second optical element is lower than a curing reaction rate of the photosensitive resin composition on a second surface thereof on a side opposite to the first surface, and wherein the light-shielding film contains a compound having a thiol group.

According to another aspect of the present disclosure, there is provided a light-shielding film to be used by being formed on an optical device including a first optical element, a second optical element, and a third optical element configured to cement the first optical element and the second optical element together, an edge surface of the first optical element and/or an edge surface of the second optical element including a chamfered portion formed in contact with an outer periphery of a cemented surface of the first optical element and/or the second optical element, so that the light-shielding film is brought into contact with the edge surface of the first optical element, the edge surface of the second optical element, and the edge surface of the third optical element, wherein the light-shielding film is a cured film of a photosensitive resin composition, wherein the light-shielding film has a first surface in contact with the edge surface of the first optical element and the edge surface of the second optical element, and a second surface on a side opposite to the first surface, wherein a curing reaction rate of the photosensitive resin composition on the first surface is lower than a curing reaction rate of the photosensitive resin composition on the second surface, and wherein the light-shielding film contains a compound having a thiol group.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view for illustrating an example of a light-shielding film and a lens having the light-shielding film formed thereon.

FIG. 2 is a schematic view for illustrating the traveling direction of internally reflected light.

FIG. 3 is a schematic sectional view of a cemented lens.

FIG. 4A is an enlarged schematic sectional view of a cemented lens edge surface of the cemented lens including chamfered portions when there is no protrusion of a third optical element.

FIG. 4B is an enlarged schematic sectional view of the cemented lens edge surface of the cemented lens including chamfered portions when there is a protrusion of the third optical element.

FIG. 5 is an enlarged schematic sectional view for illustrating features of a light-shielding film according to the present disclosure in the cemented lens including chamfered portions.

FIG. 6 is an enlarged schematic sectional view of the edge surface of the cemented lens including chamfered portions and rounded portions.

FIG. 7 is a schematic sectional view of an image pickup apparatus in a state in which a lens unit (optical system) is mounted on an image pickup unit.

FIG. 8 is a schematic view for illustrating a method of measuring an internal reflectance.

FIG. 9 is a schematic sectional view of a test piece to be used for evaluating a ratio of curing reaction rates, a ratio of elastic moduli, thermal shock resistance, and cleaning resistance.

### DESCRIPTION OF THE EMBODIMENTS

First, the role of a light-shielding film for an optical device is described with reference to the drawings.

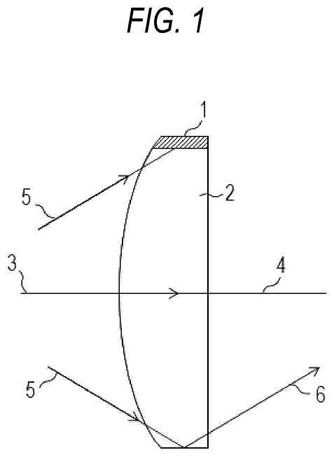

FIG. 1 is a schematic view for illustrating an example of a light-shielding film and a lens having the light-shielding film formed thereon.

As illustrated in FIG. 1, a light-shielding film 1 is formed on any outer peripheral portion of a lens 2. Here, out of light entering the lens 2, light (incident light 3) that does not strike the outer peripheral portion of the lens 2 passes through the lens 2 as transmitted light 4. Meanwhile, out of the light entering the lens 2, light (incident light 5) that strikes the outer peripheral portion of the lens 2 strikes the light-shielding film 1 formed on the outer peripheral portion of the lens 2.

If the light-shielding film 1 of FIG. 1 is not formed, the light that has struck the outer peripheral portion of the lens 2 is internally reflected to exit the lens 2 as internally reflected light 6 that has no influence on an image. The internally reflected light 6 causes flare, ghosting, and the like, which are factors for degrading image quality. Thus, it is required to form the light-shielding film 1 on the outer periphery of the lens 2 in order to prevent the occurrence of flare, ghosting, and the like. When the light-shielding film 1 is formed, the internally reflected light 6 that adversely affects an image is reduced, and hence flare, ghosting, and the like can be prevented.

The principle of the internal reflection is described in detail with reference to the drawings.

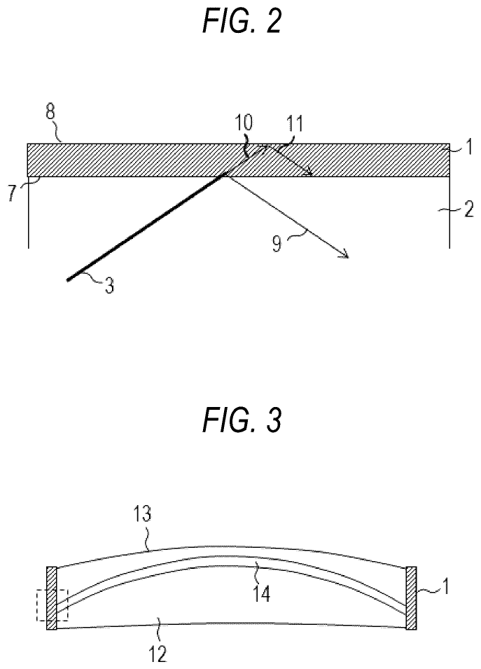

FIG. 2 is a schematic view for illustrating the traveling direction of the internally reflected light. FIG. 2 is a view for illustrating a mode in which the light-shielding film 1 is applied to the outer peripheral surface of the lens 2.

As illustrated in FIG. 2, the internal reflection occurs mainly at two interfaces, that is, an interface 7 between the lens 2 and the light-shielding film 1, and an interface 8 between the light-shielding film 1 and air. Specifically, when the incident light 3 that passes through the lens 2 strikes the interface 7, the incident light 3 is divided into light (first reflected light 9) that is reflected at the interface 7 and light (transmitted light 10) that passes through the light-shielding film 1. In addition, the transmitted light 10 generates reflected light at the interface 8. The reflected light in this case serves as second reflected light 11.

Here, the first reflected light 9 can be reduced by adjusting the refractive index of the light-shielding film 1 to be closer to that of the lens 2, or by setting the refractive index of the light-shielding film 1 higher than that of the lens 2. Along with an increase in refractive index of glass, it is required that the refractive index of the light-shielding film be also increased.

In addition, the second reflected light 11 can be reduced by absorbing the transmitted light 10 in the light-shielding film 1. In order to efficiently absorb the transmitted light 10 that has entered the light-shielding film 1, a colorant or the like is used.

Next, an example of an optical element including a chamfered portion is described through use of a cemented lens.

FIG. 3 is a schematic sectional view of a cemented lens. The cemented lens is formed of a plurality of lenses, for example, a first optical element 12, a second optical element 13, and a third optical element 14 as illustrated in FIG. 3. Further, the light-shielding film 1 is formed in contact with an edge surface of the first optical element 12, an edge surface of the second optical element 13, and an edge surface of the third optical element 14.

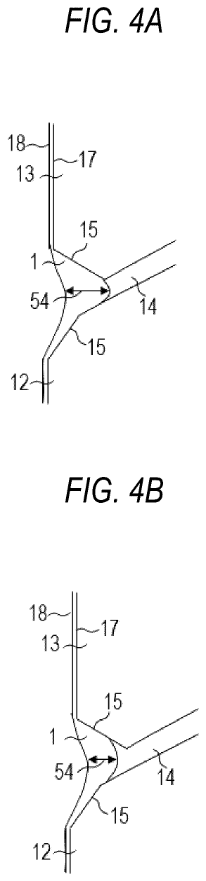

FIG. 4A is an enlarged schematic sectional view of a cemented lens edge surface of the cemented lens including chamfered portions when there is no protrusion of the third optical element 14 (adhesive). In order to prevent the lenses from colliding with each other to cause cracking of the lenses, a chamfered portion 15 is formed on each of an end portion of the first optical element 12 and an end portion of the second optical element 13. When the light-shielding film 1 is formed on the lens including the chamfered portions 15, a groove is formed in the chamfered portions to cause liquid pooling of the light-shielding film 1.

In recent years, the optical device has often been used under a situation subjected to a large thermal shock, such as a cold region or a region under scorching heat. Thus, there is a demand for reducing the stress on the lens caused by the light-shielding film 1. However, in the cemented lens, the light-shielding film 1 tends to be accumulated in the chamfered portions 15, and hence a stress is built up in a liquid pooling portion. Further, when a large thermal shock is applied, the stress may be transmitted to the first optical element 12 or second optical element 13 of the optical device to cause peeling of the light-shielding film 1, flaws or cracks in the optical elements, and the like.

In addition, in order to remove the adhesion of extremely fine contaminants to the lens that occurs in the production process of the lens, it is required that, after the formation of the light-shielding film 1, ultrasonic cleaning be performed on the lens in a tank filled with water or a detergent. It is required that no peeling of the light-shielding film 1 due to water or ultrasonic vibrations occur at the interface with the lens at the time of cleaning.

In addition, in order to improve the production efficiency of the lens, it is required to form the light-shielding film 1 in a short period of time, perform ultrasonic cleaning immediately after the formation of the light-shielding film 1, and then proceed to the next step. Thus, the light-shielding film 1 is required to be both curable in a short period of time and resistant to ultrasonic cleaning with water immediately after curing.

Exemplary embodiments of the present disclosure are described below.

First, a method of achieving an optical device, in which a light-shielding film can be cured in a short period of time, cleaning resistance is high even immediately after curing, lens cracking does not occur even under a severe thermal shock, and internal reflection preventing performance is high, is described. In addition to the method, an optical system and optical equipment each including such optical device are described, and a light-shielding paint and a light-shielding film to be used in the present disclosure are further described.

[Material for Obtaining Light-Shielding Film with Short-Time Curing, High Cleaning Resistance Immediately after Curing, High Thermal Shock Resistance, and High Internal Reflection Preventing Performance]

In order to suppress internal reflection, it is preferred that the refractive index of the light-shielding film be set to be equal to or more than that of the lens. In order to improve the refractive index, a large amount of highly refractive inorganic particles that are nano-dispersed in a resin may be added. However, the inorganic particles have a high elastic modulus, and hence the addition of a large amount of the inorganic particles makes the film itself hard to cause a large stress to be applied to the lens, with the result that thermal shock resistance may be degraded. In addition, the addition of a large amount of the inorganic particles reduces adhesion strength, and cleaning resistance may be degraded.

In order to improve the thermal shock resistance, the addition of a flexible resin is conceived. However, while the thermal shock resistance is improved, the adhesiveness of the light-shielding film is reduced, and hence the cleaning resistance may be degraded.

In order to improve the cleaning resistance, an improvement in adhesiveness of the light-shielding film is required, and an increase in clastic modulus of the resin is conceived. However, when the elastic modulus of the resin is high, the thermal shock resistance may be degraded.

Accordingly, the thermal shock resistance, the cleaning resistance, and the internal reflection preventing performance are conflicting requirements, and hence it is difficult to achieve those requirements at the same time.

(Method of Achieving Short-Time Curing, Cleaning Resistance Immediately after Curing, Thermal Shock Resistance, and High Internal Reflection Preventing Performance)

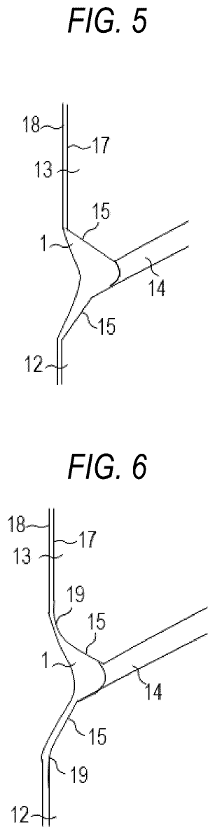

FIG. 5 is an enlarged schematic sectional view for illustrating features of a light-shielding film according to the present disclosure in a cemented lens including chamfered portions.

The inventors have made intensive investigations on a method of achieving short-time curing, cleaning resistance immediately after curing, thermal shock resistance, and high internal reflection preventing performance, and as a result, have found that those requirements can be achieved by the following configuration. First, the light-shielding film 1 is a cured film of a photosensitive resin composition. The curing reaction rate of the photosensitive resin composition on a first surface 17 of the light-shielding film 1 in contact with the edge surface of the first optical element 12 and the edge surface of the second optical element 13 is lower than the curing reaction rate of the photosensitive resin composition on a second surface 18 thereof on a side opposite to the first surface 17. In addition, the light-shielding film 1 contains a compound having a thiol group.

That is, the optical device according to the present disclosure is an optical device including: the first optical element 12; the second optical element 13; the third optical element 14 configured to cement the first optical element 12 and the second optical element 13 together; and the light-shielding film 1 continuously formed in contact with an edge surface of the first optical element 12, an edge surface of the second optical element 13, and an edge surface of the third optical element 14, wherein the light-shielding film 1 is a cured film of a photosensitive resin composition, wherein the edge surface of the first optical element 12 and/or the edge surface of the second optical element 13 includes a chamfered portion 15 formed in contact with an outer periphery of a cemented surface of the first optical element 12 and/or the second optical element 13, wherein a curing reaction rate of the photosensitive resin composition on the first surface 17 of the light-shielding film 1 in contact with the edge surface of the first optical element 12 and the edge surface of the second optical element 13 is lower than a curing reaction rate of the photosensitive resin composition on the second surface 18 thereof on a side opposite to the first surface 17, and wherein the light-shielding film 1 contains a compound having a thiol group.

The light-shielding film 1 according to the present disclosure is a cured film of a photosensitive resin composition and contains a photopolymerization initiator. The photosensitive resin composition containing the photopolymerization initiator can be cured in a short period of time by polymerization with a UV irradiation device or the like. The light-shielding film 1 formed in the optical device according to the present disclosure is a cured film of a photosensitive resin composition, and hence has a short curing time as compared to a cured film of a thermosetting, room temperature-curable, or moisture-curable resin composition.

In addition, the curing reaction rate of the first surface 17 of the light-shielding film 1 formed in the optical device according to the present disclosure is lower than that of the second surface 18 thereof on a side opposite to the first surface 17. The light-shielding film according to the present disclosure has a light-shielding function. Thus, in particular, when a portion having a large thickness as in the chamfered portions 15 is cured mainly from the surface side with a UV irradiation device or the like, the curing reaction rate of the second surface 18 is high, and the curing reaction rate of the first surface 17 having a low light transmittance in the thick portion is low.

The light-shielding film 1 according to the present disclosure has high thermal shock resistance because the curing reaction rate of the first surface 17 is low. When the curing reaction rate of the first surface 17 is low, water is liable to enter the light-shielding film 1 at the time of cleaning to cause peeling of the film. However, it is presumed that the light-shielding film 1 according to the present disclosure contains a compound having a thiol group, and hence the cleaning resistance is increased even immediately after curing. The reaction between the compound having a thiol group and water is described below.

In general, the compound having a thiol group has a function of reacting with an acryloyl group, an epoxy group, an aryl group, or the like to accelerate curing, and is used as a curing accelerator. The addition of the compound having a thiol group can accelerate curing, and the cleaning resistance tends to be slightly improved. However, light does not reach the first surface 17 in the portion having a large thickness as in the chamfered portions 15. Thus, even when the compound having a thiol group is added, the curing reaction rate of the first surface 17 is lower than that of the second surface 18, though the curing reaction rate is slightly improved.

The curing reaction rate of the first surface 17 of the light-shielding film 1 according to the present disclosure is low. Thus, it is presumed that when the light-shielding film 1 is immersed in water, water is liable to enter the film. It is presumed that the hydroxy group of the water having entered the light-shielding film 1 reacts with the compound having a thiol group to convert the compound having a thiol group into a thiolate anion having high nucleophilicity, and the thiolate anion reacts with a photosensitive resin material to further improve the curing reaction rate of the photosensitive resin material, to thereby enhance the water resistance of the film. Thus, the light-shielding film according to the present disclosure contains the compound having a thiol group, and hence a film having high water resistance can be obtained immediately after curing even when the curing reaction is insufficient.

### [Optical Device]

The optical device according to the present disclosure is an optical device to be used, for example, in a lens barrel that is optical equipment to be used together with an image pickup apparatus, such as a camera, a video camera, or broadcasting equipment, or in a camera body, a video body, a surveillance camera, an in-vehicle camera, a weather camera, or the like that may be used outdoors. The optical device according to the present disclosure includes a first optical element including a chamfered portion on a cemented surface side, a second optical element including a chamfered portion on the cemented surface side, and a third optical element that cements the first optical element and the second optical element together.

An optical device having any shape may be used as the optical device such as a lens. For example, an optical device having a concave surface, a convex surface, or a combination thereof may be used. In addition, the outer peripheral portion may be flat, have a plurality of steps, or have grooves. In addition, the outer peripheral portion of the lens may have a straight portion. In addition, any material may be used as a constituent component for the base material of a lens or the like. Examples thereof include Li₂O, Na₂O, K₂O, MgO, CaO, SrO, BaO, ZnO, Y₂O₃, La₂O₃, Nd₂O₃, Gd₂O₃, B₂O₃, Al₂O₃, TiO₂, ZrO₂, HfO₂, SiO₂, GeO, Nb₂O₅, Ta₂O₅, P₂O₅, Sb₂O₃, and WO₃. The constituent components may be used alone or in combination thereof.

In addition, as described above, the cemented lens includes the first optical element 12, the second optical element 13, the third optical element 14 that cements the first optical element 12 and the second optical element 13 together, and the light-shielding film 1, as illustrated in FIG. 3. The light-shielding film 1 is continuously formed in contact with the edge surface of the first optical element 12, the edge surface of the second optical element 13, and the edge surface of the third optical element 14.

As illustrated in FIG. 4A, the chamfered portions 15 are formed on the edge surface of the first optical element 12 and/or the edge surface of the second optical element 13 and to be in contact with the edge surface of the third optical element 14 and the cemented surface. As a result, a groove is formed with the edge surface of the third optical element 14 being a bottom surface and the chamfered portions 15 being wall surfaces. Thus, the light-shielding film 1 is formed so as to fill at least part of the groove.

FIG. 4B is an enlarged schematic sectional view of a cemented lens edge surface of the cemented lens including the chamfered portions 15 when there is a protrusion of the third optical element 14 (adhesive). As illustrated in FIG. 4B, the third optical element 14 may protrude into the chamfered portions 15. A maximum thickness 54 of the light-shielding film 1 in the groove becomes large as illustrated in FIG. 4A when there is no protrusion of the third optical element 14 and becomes small as illustrated in FIG. 4B when there is a protrusion of the third optical element 14.

The chamfered portions 15 are formed in order to prevent the first optical element 12 and the second optical element 13 from colliding with each other to cause minute cracks at the time of production. The length of each of the chamfered portions 15 is 0.05 mm or more and 0.5 mm or less, more preferably 0.1 mm or more and 0.4 mm or less. When the length of each of the chamfered portions 15 is less than 0.05 mm, microcracks may be liable to be formed when the first optical element 12 and the second optical element 13 collide with each other. When the length of each of the chamfered portions 15 is more than 0.5 mm, the light-shielding film 1 is liable to be accumulated to increase the stress on the lens, with the result that the thermal shock resistance may be degraded.

In addition, there is no particular limitation on the number of lenses to be cemented in the cemented lens, and two lenses may be cemented, or more than two lenses may be cemented to be used.

The optical device according to the present disclosure may have a rounded portion. The rounded portion is described with reference to FIG. 6. FIG. 6 is an enlarged schematic sectional view of an edge surface of a cemented lens including chamfered portions and rounded portions. As illustrated in FIG. 6, the chamfered portion 15 on the cemented surface side of the first optical element 12 may have a rounded portion 19. When the rounded portion 19 is formed, the light-shielding film 1 easily flows out owing to its own weight when the light-shielding film 1 is formed, and the light-shielding film 1 is less liable to be accumulated in the groove of the chamfered portions. When the light-shielding film 1 is hardly accumulated in the groove of the chamfered portions, a stress is hardly generated even when a thermal shock is applied, and the thermal shock resistance is further improved.

The maximum diameter of the optical device according to the present disclosure is preferably 5 mm or more and 1,000 mm or less, more preferably 25 mm or more and 100 mm or less. A cemented lens in which the maximum diameter of the optical device is less than 5 mm is excessively small, and hence it may be difficult to produce such device. In addition, when the maximum diameter of the optical device is more than 1,000 mm, a stress is generated on the lens, and the thermal shock resistance may be degraded.

In addition, examples of products commercially available as the glass to be used in the base material as the first optical element 12 and the second optical element 13 include: S-LAM2 (7.4 ppm), S-LAM60 (5.4 ppm), S-TIH53 (8.8 ppm), S-BSL7 (7.2 ppm), S-NBM51 (6.5 ppm), L-BAL42 (7.2 ppm), S-FPL55 (13.6 ppm), S-FPL51 (13.1 ppm), S-FPM3 (11.5 ppm), S-FSL5 (9 ppm), S-FPL53 (14.5 ppm), S-FPM4 (12.4 ppm), S-NSL36 (8 ppm), and S-TIL6 (8.2 ppm), all of which are manufactured by Ohara Inc.; and quartz (0.5 ppm). In addition, equivalent products are commercially available from Schott AG, HOYA Corporation, and the like, and hence those products may be used.

The third optical element 14 is a layer obtained by curing an adhesive to be used for bonding lenses made of glass to each other. The adhesive is required to have a high adhesive force and a high curing speed in addition to optical transparency, and curable adhesives, such as an acrylic curable adhesive, an epoxy-based curable adhesive, and a polyene-polythiol-based curable adhesive, may be suitably used. A curing initiator may be added to those adhesives, and the adhesives may be cured with heat or UV light. However, curing with heat may cause interface peeling or deformation of a surface shape. Thus, it is desired that a UV-curable adhesive be used as the adhesive for the third optical element 14. In addition, from the viewpoints of reducing the curing shrinkage of the adhesive and adjusting the optical characteristics thereof, an adhesive in which inorganic fine particles or the like are mixed and dispersed is preferably used. In addition, the maximum thickness of the light-shielding film in contact with the third optical element is preferably 5 μm or more and 180 μm or less.

An anti-reflection film (not shown) may be formed on each of the first optical element 12 and the second optical element 13.

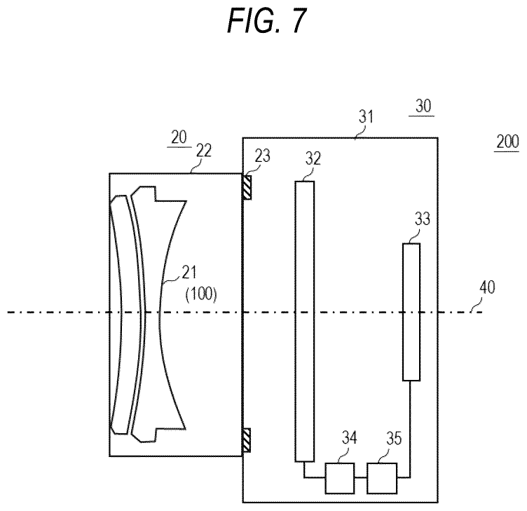

In addition, the cemented lens is used as an optical system or a part of an optical system in an image pickup apparatus (including a camera, a video camera, or the like) including an image pickup device or in optical equipment, such as a telescope, binoculars, a copying machine, or a projector. FIG. 7 is a schematic sectional view of an image pickup apparatus in a state in which a lens unit (optical system) that is an interchangeable lens is mounted on an image pickup unit. As an example, a schematic cross-section of an image pickup apparatus 200 in a state in which a lens unit (optical system) 20 is mounted on an image pickup unit 30 is illustrated in FIG. 7. A cemented lens 21 (100) is arranged in a barrel 22 serving as a housing of the lens unit 20, and the lens unit is fixed to the image pickup unit 30 with a mount 23. The image pickup unit 30 includes an image pickup device 33 that receives light having passed through the lens unit 20 and a shutter 32 in a housing 31. The image pickup device 33 is arranged so that an optical axis 40 of the cemented lens 21 passes through a center thereof so as to receive light having passed through the lens unit 20. Further, the image pickup unit 30 includes a drive unit 34 that opens and closes the shutter 32, and a control unit 35 that controls data readout and the like from the drive unit 34 and the image pickup device 33.

### [Light-Shielding Paint]

The material configuration of a light-shielding paint serving as a precursor of a light-shielding film to be used in the present disclosure and a method of producing a light-shielding paint to be used in the present disclosure are described below.

The light-shielding paint is a constituent element corresponding to a photosensitive resin composition in the present disclosure.

### <Material Configuration>

### (Photosensitive Resin Material)

A photosensitive resin material in the light-shielding paint to be used in the present disclosure is described.

Any appropriate material may be used as the photosensitive resin material in the light-shielding paint to be used in the present disclosure as long as the material can form a light-shielding film. It is only required that the photosensitive resin material in the light-shielding paint to be used in the present disclosure have reactivity with UV light, and a plurality of photosensitive resin materials may be used in combination with a thermosetting, moisture-curable, or room temperature-curable resin. The photosensitive resin material may be a polymerizable compound. Examples of the photosensitive resin material include an acrylate resin, an epoxy resin, a urethane resin, an acrylic urethane resin, a phenol resin, a melamine resin, a polyester resin, an alkyd resin, an aryl resin, and polyimide.

The polymerizable compound in the photosensitive resin composition preferably has an acryloyl group and a hydroxy group.

As the acrylate resin, specifically, for example, a material selected from M-208 (Toagosci Co., Ltd.), M-211B (Toagosei Co., Ltd.), M-215 (Toagosci Co., Ltd.), M-220 (Toagosei Co., Ltd.), M-225 (Toagosci Co., Ltd.), M-270 (Toagosei Co., Ltd.), M-309 (Toagosei Co., Ltd.), M-310 (Toagosci Co., Ltd.), M-321 (Toagosei Co., Ltd.), M-350 (Toagosci Co., Ltd.), M-360 (Toagosei Co., Ltd.), M-313 (Toagosci Co., Ltd.), M-315 (Toagosci Co., Ltd.), M-306 (Toagosei Co., Ltd.), M-305 (Toagosci Co., Ltd.), M-450 (Toagosei Co., Ltd.), M-408 (Toagosei Co., Ltd.), DPGDA (Daicel-Allnex Ltd.), HDDA (Daicel-Allnex Ltd.), TPGDA (Daicel-Allnex Ltd.), EBECRYL 145 (Daicel-Allnex Ltd.), EBECRYL 150 (Daicel-Allnex Ltd.), PEG200DA (Daicel-Allnex Ltd.), EBECRYL 11 (Daicel-Allnex Ltd.), IRR 214-K (Daicel-Allnex Ltd.), EBECRYL 130 (Daicel-Allnex Ltd.), TMPTA (Daicel-Allnex Ltd.), EBECRYL 160S (Daicel-Allnex Ltd.), OTA 480 (Daicel-Allnex Ltd.), PETIA (Daicel-Allnex Ltd.), PETRA (Daicel-Allnex Ltd.), EBECRYL 40 (Daicel-Allnex Ltd.), EBECRYL 50 (Daicel-Allnex Ltd.), PETA (Daicel-Allnex Ltd.), EBECRYL 140 (Daicel-Allnex Ltd.), EBECRYL 1140 (Daicel-Allnex Ltd.), EBECRYL 1142 (Daicel-Allnex Ltd.), DPHA (Daicel-Allnex Ltd.), EBECRYL 895 (Daicel-Allnex Ltd.), OGSOL EA-0200 (Osaka Gas Chemicals Co., Ltd.), OGSOL EA-F5710 (Osaka Gas Chemicals Co., Ltd.), OGSOL EA-5060P (Osaka Gas Chemicals Co., Ltd.), OGSOL EA-0300 (Osaka Gas Chemicals Co., Ltd.), OGSOL GA-2800 (Osaka Gas Chemicals Co., Ltd.), Light Acrylate L-A (Kyocisha Chemical Co., Ltd.), Light Acrylate S-A (Kyocisha Chemical Co., Ltd.), Light Acrylate EC-A (Kyocisha Chemical Co., Ltd.), Light Acrylate EHDG-AT (Kyocisha Chemical Co., Ltd.), Light Acrylate 130A (Kyocisha Chemical Co., Ltd.), Light Acrylate DPM-A (Kyocisha Chemical Co., Ltd.), Light Acrylate PO-A (Kyocisha Chemical Co., Ltd.), Light Acrylate P2H-A (Kyocisha Chemical Co., Ltd.), Light Acrylate P-200A (Kyocisha Chemical Co., Ltd.), Light Acrylate THF-A (Kyocisha Chemical Co., Ltd.), Light Acrylate IB-XA (Kyocisha Chemical Co., Ltd.), Light Acrylate 9EG-A (Kyocisha Chemical Co., Ltd.), Light Acrylate 14EG-A (Kyoeisha Chemical Co., Ltd.), Light Acrylate NP-A (Kyocisha Chemical Co., Ltd.), Light Acrylate MPD-A (Kyocisha Chemical Co., Ltd.), Light Acrylate 1.6HX-A (Kyocisha Chemical Co., Ltd.), Light Acrylate 1.9ND-A (Kyocisha Chemical Co., Ltd.), Light Acrylate DCP-A (Kyocisha Chemical Co., Ltd.), Light Acrylate BP-4EAL (Kyocisha Chemical Co., Ltd.), Light Acrylate HPP-A (Kyocisha Chemical Co., Ltd.), Light Ester G-201P (Kyocisha Chemical Co., Ltd.), Light Acrylate TMP-A (Kyocisha Chemical Co., Ltd.), Light Acrylate PE-3A (Kyocisha Chemical Co., Ltd.), Light Acrylate PE-4A (Kyocisha Chemical Co., Ltd.), and Light Acrylate DPE-6A (Kyocisha Chemical Co., Ltd.) may be preferably used.

The content of the photosensitive resin material in the light-shielding paint to be used in the present disclosure is preferably 5 wt % or more and 87 wt % or less, more preferably 30 wt % or more and 85 wt % or less. When the content of the photosensitive resin material in the light-shielding paint to be used in the present disclosure is less than 5 wt %, the light-shielding film becomes excessively hard, and film cracking may be caused by a thermal shock. When the content of the photosensitive resin material is more than 87 wt %, it may become difficult to increase the refractive index of the film. All the values of the weight percent described herein are values based on solid content, excluding the content of a volatile component.

### (Colorant)

The light-shielding paint to be used in the present disclosure may contain a colorant.

Any appropriate material may be used as the colorant as long as the material can color the light-shielding paint. Examples of the colorant in the light-shielding paint include a dye and a pigment. Those colorants may be used alone or as a mixture thereof.

Examples of the dye include an azo dye, a quinone-based dye, a cyanine-based dye, a cation-based dye, a phthalocyanine-based dye, an indigo-based dye, and a fulgide-based dye. In addition, a dye having any color tone may be used, and examples thereof include a black tone, a brown tone, a yellow tone, a red tone, a blue tone, and a green tone. Those dyes may be used alone or as a mixture thereof.

Examples of the pigment include carbon black, titanium black, zirconium nitride, iron oxide, a copper-iron-manganese composite oxide, and iron-chromium. A pigment having any shape may be used as the pigment in the light-shielding paint. Examples of the shape of the pigment in the light-shielding paint include a spherical shape, an amorphous shape, a plate shape, a needle shape, a star shape, a chain shape, and a multilayer configuration in which plate-like particles are laminated. In addition, the pigment in the light-shielding paint may be coated with another material. The average particle diameter of the pigment in the light-shielding paint is preferably 1 nm or more and 200 nm or less, more preferably 5 nm or more and 50 nm or less. When the average particle diameter of the pigment in the light-shielding paint is less than 1 nm, the paint may be thickened. In addition, when the average particle diameter of the pigment is more than 200 nm, the scattering of light by the film may be increased.

The content of the colorant in the light-shielding paint is preferably 1 wt % or more and 30 wt % or less, more preferably 2 wt % or more and 20 wt % or less. When the content of the colorant in the light-shielding paint is less than 1 wt %, the light having entered the film cannot be fully absorbed, and the internal reflection characteristic may be degraded. In addition, when the content of the colorant in the light-shielding paint is more than 30 wt %, the film may become excessively hard. All the values of the weight percent described herein are values based on solid content, excluding the content of a volatile component.

The light-shielding paint to be used in the present disclosure is formed into a light-shielding film having an optical density ODt of preferably 0.14 μm⁻¹ or more and 0.53 μm⁻¹ or less, more preferably 0.2 μm⁻¹ or more and 0.5 μm⁻¹ or less. The ODt refers to an absorbance per 1 μm. The ODt may be calculated by determining an absorbance-log₁₀(I/I0) using an average value I of transmittances at wavelengths of from 400 nm to 700 nm and an incident light intensity I0, and dividing the absorbance by a film thickness “t”.

$$ODt = - {log}_{10} ( I / I 0 ) / t \qquad Equation ( 1 )$$

When the ODt is less than 0.14 μm⁻¹, the incident light cannot be fully absorbed, and the optical characteristics may be degraded. When the ODt is more than 0.53 μm⁻¹, a curing failure may occur at the time of irradiation with UV light.

As the colorant, specifically, for example, a material selected from #2650 (Mitsubishi Chemical Corporation), #2600 (Mitsubishi Chemical Corporation), #2350 (Mitsubishi Chemical Corporation), #2300 (Mitsubishi Chemical Corporation), #1000 (Mitsubishi Chemical Corporation), #980 (Mitsubishi Chemical Corporation), #970 (Mitsubishi Chemical Corporation), #960 (Mitsubishi Chemical Corporation), #950 (Mitsubishi Chemical Corporation), #850 (Mitsubishi Chemical Corporation), MCF88 (Mitsubishi Chemical Corporation), MA600 (Mitsubishi Chemical Corporation), #750B (Mitsubishi Chemical Corporation), #650B (Mitsubishi Chemical Corporation), MA100 (Mitsubishi Chemical Corporation), and MA220 (Mitsubishi Chemical Corporation) may be preferably used.

### (Inorganic Particles)

The inorganic particles in the light-shielding paint to be used in the present disclosure are described.

The average particle diameter of the inorganic particles in the light-shielding paint to be used in the present disclosure is preferably 2 nm or more and 250 nm or less, more preferably 50 nm or more and 200 nm or less, still more preferably 100 nm or more and 180 nm or less. When the average particle diameter of the inorganic particles is more than 200 nm, the scattering of light by the light-shielding film is increased, and the external appearance of the film may be degraded.

The d-line refractive index of the inorganic particles in the light-shielding paint to be used in the present disclosure is preferably 1.6 or more and 3.1 or less. The d-line refractive index is more preferably 2.0 or more and 3.1 or less. When the d-line refractive index is less than 1.6, a large amount of particles are required to be added in order to increase the refractive index of the light-shielding film according to the present disclosure. Thus, the clastic modulus of the light-shielding film is increased, and the thermal shock resistance may be degraded.

The content of the inorganic particles in the light-shielding paint to be used in the present disclosure is preferably 2 wt % or more and 60 wt % or less, and more preferably falls within a range of 5 wt % or more and 30 wt % or less. When the content of the inorganic particles in the light-shielding paint to be used in the present disclosure is less than 2 wt %, the refractive index of the light-shielding film is not increased significantly, and the internal reflection preventing performance may be degraded. In addition, when the content of the inorganic particles in the light-shielding paint to be used in the present disclosure is more than 60 wt %, the clastic modulus of the light-shielding film to be used in the present disclosure may become excessively high, and the thermal shock resistance may not be improved. All the values of the weight percent described herein are values based on solid content, excluding the content of a volatile component.

Any appropriate metal, metal oxide, or the like may be used as the kind of the inorganic particles in the light-shielding paint to be used in the present disclosure as long as the d-line refractive index is 1.6 or more and 3.1 or less. Examples of the inorganic particles having a d-line refractive index of 1.6 or more in the light-shielding paint to be used in the present disclosure include colcothar (d-line refractive index=3.01), magnetite (d-line refractive index=2.42), rutile-type titanium oxide (d-line refractive index=2.72), anatase-type titanium oxide (d-line refractive index=2.52), zirconium oxide (d-line refractive index=2.05), cerium oxide (d-line refractive index=2.2), zinc oxide (d-line refractive index=2.1), tantalum pentoxide (d-line refractive index=2.16), aluminum nitride (d-line refractive index=1.9 to 2.2), tungsten oxide (d-line refractive index=2.2), niobium pentoxide (d-line refractive index=2.33), indium tin oxide (d-line refractive index=2.06), chromium oxide (d-line refractive index=2.24), diamond (d-line refractive index=2.42), aluminum oxide (d-line refractive index=1.63), cerium fluoride (d-line refractive index=1.63), yttrium oxide (d-line refractive index=1.87), magnesium oxide (d-line refractive index=1.74), hafnium oxide (d-line refractive index=1.95), lanthanum oxide (d-line refractive index=1.84), scandium oxide (d-line refractive index=1.89), europium oxide (d-line refractive index=1.90), molybdenum oxide (d-line refractive index=1.90), samarium fluoride (d-line refractive index=1.90), prascodymium oxide (d-line refractive index=1.92), silicon (d-line refractive index=3.4), and a copper-iron-manganese composite oxide.

The inorganic particles having a d-line refractive index of 1.6 or more in the light-shielding paint to be used in the present disclosure may be used alone or in combination thereof, or may be used in the form of a composite.

Inorganic particles having any shape may be used as the inorganic particles in the light-shielding paint to be used in the present disclosure. Examples of the shape of the inorganic particles in the light-shielding paint to be used in the present disclosure include a spherical shape, an amorphous shape, a plate shape, a needle shape, a star shape, a chain shape, and a multilayer configuration in which plate-like particles are laminated. In addition, the inorganic particles in the light-shielding paint to be used in the present disclosure may be coated with another material. In addition, the inorganic particles in the light-shielding paint to be used in the present disclosure may be used alone or in combination thereof.

As the inorganic particles, specifically, for example, a material selected from TTO-51 (A) (Ishihara Sangyo Kaisha, Ltd.), TTO-51 (C) (Ishihara Sangyo Kaisha, Ltd.), TTO-55 (A) (Ishihara Sangyo Kaisha, Ltd.), TTO-55 (B) (Ishihara Sangyo Kaisha, Ltd.), TTO-55 (C) (Ishihara Sangyo Kaisha, Ltd.), TTO-55 (D) (Ishihara Sangyo Kaisha, Ltd.), STR-100N (Sakai Chemical Industry Co., Ltd.), STR-100A-LP (Sakai Chemical Industry Co., Ltd.), STR-100C-LP (Sakai Chemical Industry Co., Ltd.), STR-100W-LP (Sakai Chemical Industry Co., Ltd.), STR-100C-LF (Sakai Chemical Industry Co., Ltd.), STR-100W-OTS (Sakai Chemical Industry Co., Ltd.), STR-100W (G) (Sakai Chemical Industry Co., Ltd.), STR-40-OTS (Sakai Chemical Industry Co., Ltd.), MT-01 (Tayca Corporation), MT-10EX (Tayca Corporation), MT-05 (Tayca Corporation), MT-100S (Tayca Corporation), MT-100TV (Tayca Corporation), MT-100Z (Tayca Corporation), MT-150EX (Tayca Corporation), MT-150W (Tayca Corporation), MT-100AQ (Tayca Corporation), MT-100WP (Tayca Corporation), MT-100SA (Tayca Corporation), and MT-100HD (Tayca Corporation) may be preferably used.

### (Photopolymerization Initiator)

The light-shielding paint according to the present disclosure contains a photopolymerization initiator in the film. When the photopolymerization initiator is added to the light-shielding paint and UV light is applied, the curing reaction rate of the first surface becomes lower than that of the second surface. In addition, when the photopolymerization initiator is used, no heat is applied to the optical device in the curing of the light-shielding paint. Thus, the stress is reduced, and the thermal shock resistance is improved. The photopolymerization initiators in the present disclosure may be used alone or in combination thereof, and any material may be used. Examples thereof include a radical-based photopolymerization initiator, a cation-based photopolymerization initiator, and an anion-based photopolymerization initiator. Examples of the radical-based photopolymerization initiator include an alkylphenone-based photopolymerization initiator, an acyl phosphine oxide-based photopolymerization initiator, an intramolecular hydrogen abstraction-type photopolymerization initiator, and an oxime ester-based photopolymerization initiator. Examples of the cation-based photopolymerization initiator include iodonium-based, sulfonium-based, ammonium-based, and nonionic photopolymerization initiators.

The content of the photopolymerization initiator in the light-shielding paint is preferably 0.1 wt % or more and 15 wt % or less, and more preferably falls within a range of 0.5 wt % or more and 5 wt % or less. When the content of the photopolymerization initiator is less than 0.1 wt %, the reaction does not proceed at the time of irradiation with UV light, and the cleaning resistance may be degraded. In addition, when the content of the photopolymerization initiator is more than 15 wt %, the photopolymerization initiator may seep from the film to alter the glass component.

As the photopolymerization initiator, specifically, for example, a material selected from Omnirad 651 (IGM Resins), Omnirad 184 (IGM Resins), Omnirad 1173 (IGM Resins), Omnirad 2959 (IGM Resins), Omnirad 127D (IGM Resins), Omnirad 907 (IGM Resins), Omnirad 369 (IGM Resins), Omnirad 369E (IGM Resins), Omnirad 379EG (IGM Resins), Omnirad TPO N (IGM Resins), Omnirad 819 (IGM Resins), Omnirad TPO-L (IGM Resins), Omnipol TP (IGM Resins), Omnirad MBF (IGM Resins), Omnirad 754 (IGM Resins), Esacure 3644 (IGM Resins), Irgacure OXE01 (BASF SE), Irgacure OXE02 (BASF SE), Irgacure OXE03 (BASF SE), Irgacure OXE04 (BASF SE), Irgacure OXE05 (BASF SE), Omnicat 270 (IGM Resins), Irgacure 290 (IGM Resins), Nikkacure YJ-04 (T) (Nippon Chemical Industrial Co., Ltd.), Nikkacure IW-15 (Nippon Chemical Industrial Co., Ltd.), Nikkacure TG-05 (Nippon Chemical Industrial Co., Ltd.), Nikkacure TG-10 (Nippon Chemical Industrial Co., Ltd.), and Nikkacure TKG-01 (Nippon Chemical Industrial Co., Ltd.) may be preferably used.

### (Compound Having Thiol Group)

In the present disclosure, the light-shielding paint contains a compound having a thiol group. The compound having a thiol group may be a monofunctional thiol having one thiol group or a polyfunctional thiol having two or more thiol groups, and a plurality of those compounds may be combined. In particular, the compound having a thiol group is preferably a polyfunctional thiol because the flexibility and cross-linking property of the film are improved.

The polyfunctional thiol may be an ester-type thiol or an ether-type thiol. The ether-type thiol is more preferred because the ether-type thiol has high water resistance and provides high cleaning resistance to a lens. In particular, it is preferred that the compound having a thiol group be free of an ester bond.

Examples of the compound having a thiol group include pentacrythritol tetrakis(3-sulfanylbutanoate), trimethylolpropane tris(3-mercaptobutyrate), pentaerythritol tris(3-sulfanylbutanoate), 1,3,5-tris(2-(3-sulfanylbutanoyloxy)ethyl)-1,3,5-triazinane-2,4,6-trione, 1,4-bis(3-mercaptobutylyloxy) butane, 2,2-bis {[(3-sulfanylbutanoyl)oxy]methyl}butyl 3-sulfanylbutanoate, trimethylolpropane tris(3-mercaptopropionate), pentaerythritol tetra(3-mercaptopropionate), dipentaerythritol hexakis (3-mercaptopropionate), tris[2-(3-mercaptopropionyloxy)ethyl]isocyanurate, pentaerythritol tripropanethiol, trimethylolpropane dipropanethiol 2,2-bis [(3-sulfanylpropoxy)methyl]butan-1-ol, pentaerythritol tetrapropanethiol 3-{3-(3-mercapto-propoxy)-2,2-bis-[(3-mercaptopropoxy)methyl]propoxy}-propan-1-ol, tetraethylene glycol bis(3-mercaptopropionate), tetrahydro-1,3,4,6-tetrakis(3-mercaptopropyl)-imidazo[4,5-d]imidazole-2,5(1H,3H)-dione, thionyl chloride, a reaction product of tetrahydro-1,3,4,6-tetrakis(2-hydroxyethyl) imidazo[4,5-d]imidazole-2,5 (1H,3H)-dione and thiourea (CAS Registry Number: 1852527-71-9), 1,3,5-tris [3-(2-mercaptocthylsulfanyl)propyl]isocyanurate, thiocyanuric acid, 2-ethyl-2-(mercaptomethyl)-1,3-propanedithiol, 2,2-bis(mercaptomethyl)-1,3-propanedithiol, 1,3-dimercapto-2-propanol, 2,2-bis(mercaptomethyl)-1,3-propanediol, and 3-mercapto-2,2-bis(mercaptomethyl)-1-propanol.

As the compound having a thiol group, a material selected from TMMP (Sakai Chemical Industry Co., Ltd.), TMMP-HS (Sakai Chemical Industry Co., Ltd.), PEMP (Sakai Chemical Industry Co., Ltd.), DPMP (Sakai Chemical Industry Co., Ltd.), TEMPIC (Sakai Chemical Industry Co., Ltd.), EGMP-4 (Sakai Chemical Industry Co., Ltd.), Multhiol Y-2 (Sakai Chemical Industry Co., Ltd.), Multhiol Y-3 (Sakai Chemical Industry Co., Ltd.), Multhiol Y-4 (Sakai Chemical Industry Co., Ltd.), Karenz MT BD1 (Resonac Corporation), Karenz MT NRI (Resonac Corporation), Karenz MT TPMB (Resonac Corporation) ACTOCURE SS32 (Kawaguchi Chemical Industry Co., Ltd.), and ACTOCURE ES23 (Kawaguchi Chemical Industry Co., Ltd.) may be particularly preferably used.

The content of the compound having a thiol group in the light-shielding paint is preferably 0.5 wt % or more and 40 wt % or less, more preferably in a range of 1 wt % or more and 10 wt % or less. When the content of the compound having a thiol group in the light-shielding paint is less than 0.5 wt %, the reaction does not proceed at the time of irradiation with UV light, and the cleaning resistance may be degraded. In addition, when the content of the compound having a thiol group is more than 40 wt %, the film becomes excessively flexible, and the water resistance may be degraded.

### (Other Curing Accelerator)

In the present disclosure, the light-shielding paint may contain another curing accelerator in the film. When a curing accelerator is added, the film further reacts, and hence the cleaning resistance immediately after curing is improved. Examples of the curing accelerator include a photobase generator, a photosensitizer, and an oxygen inhibition suppressor. Those curing accelerators may be used alone or in combination thereof.

Examples of the photobase generator include 1,2-diisopropyl-3-[bis(dimethylamino)methylene]guanidium 2-(3-benzoylphenyl)propionate, 1,2-dicyclohexyl-4,4,5,5-tetramethylbiguanidium n-butyltriphenylborate, (Z)-{[bis(dimethylamino)methylidene]amino}-N-cyclohexyl(cyclohexylamino)methaniminium tetrakis(3-fluorophenyl) borate, 9-anthrylmethyl N,N-diethylcarbamate, (E)-1-piperidino-3-(2-hydroxyphenyl)-2-propen-1-one, 1-(anthraquinon-2-yl)ethylimidazole-1-carboxylate, and 2-nitrophenylmethyl 4-methacryloyloxypiperidine-1-carboxylate.

Any photosensitizer or the like may be used as an example of the photosensitizer or the like. Examples thereof include coumarin-based, pyrazoline-based, thiophene-based, naphthalene-based, oxazole-based, ketosulfone-based, and thioxanthone-based photosensitizers.

Examples of the oxygen inhibition suppressor include IPEMA (Kuraray Co., Ltd), DPNG (Kuraray Co., Ltd), EBECRYL 80 (Daicel Corporation), EBECRYL 7100 (Daicel Corporation), and ADDITIOL LED 01 (Daicel Corporation).

The content of the curing accelerator in the light-shielding paint is preferably 0.1 wt % or more and 15 wt % or less, more preferably in a range of 0.5 wt % or more and 5 wt % or less. When the content of the curing accelerator is less than 0.1 wt %, the reaction does not proceed at the time of irradiation with UV light, and the cleaning resistance may be degraded. In addition, when the content of the curing accelerator is more than 15 wt %, the curing accelerator may seep from the film to alter the glass component.

### (Solvent)

Next, a solvent in the light-shielding paint is described.

Any material may be used as the solvent. In addition, when the viscosity of the light-shielding paint is sufficiently low and the light-shielding paint may be used as it is, a solvent need not be added. Examples of the solvent include water, a thinner, ethanol, isopropyl alcohol, n-butyl alcohol, ethyl acetate, propyl acetate, isobutyl acetate, butyl acetate, methyl ethyl ketone, methyl isobutyl ketone, propylene glycol monomethyl ether, propylene glycol monomethyl ether acetate, toluene, xylene, acetone, cellosolves, glycol ethers, ether, hexane, cyclohexane, 1-butanol, methylcyclohexane, ethylcyclohexane, isohexane, benzyl alcohol, 2-ethyl-1-hexanol, butyl cellosolve, 1-butoxy-2-propanol, neopentane, SOLVESSO, trichloroethylene, perchloroethylene, methanol, cellosolve acetate, mineral spirit, tetrahydrofuran, dioxane, N-methyl-2-pyrrolidone, and ethyl lactate. Those solvents may be used alone or in combination thereof.

The viscosity of the light-shielding paint to be used in the present disclosure is preferably 10 mPa's or more and 10,000 mPa's or less, more preferably 15 mPa's or more and 500 mPa's or less. When the viscosity of the light-shielding paint is less than 10 mPa·s, a region having a reduced thickness may be present after application of the paint. In addition, when the viscosity is more than 10,000 mPa·s, the applicability of the light-shielding paint may be degraded.

### (Other Additive)

The light-shielding paint to be used in the present disclosure may contain any other additive. Examples thereof include a curing agent, a dispersant, an antifoaming agent, a thixotropy-imparting agent, a leveling agent, a matting agent, a preservative, an antibacterial agent, a fungicide, a UV absorber, an antioxidant, a coupling agent, and inorganic particles and organic fine particles for adjusting the color tone other than those described above. The additive is added to the extent that the characteristics are not degraded. Examples of the curing agent include an amine-based curing agent and an isocyanate-based curing agent.

### <Method of Producing Light-Shielding Paint>

A method of producing a light-shielding paint to be used in the present disclosure is described below.

Any method may be used as the method of producing a light-shielding paint to be used in the present disclosure as long as the inorganic particles and the pigment that may be added to the light-shielding paint can be dispersed in the light-shielding paint. Examples of thereof include methods each using a bead mill, a ball mill, a jet mill, a three-roll mill, a planetary rotary device, a mixer, an ultrasonic disperser, and a homogenizer.

When the average particle diameter of the inorganic particles is more than 200 nm, the film scatters light, and hence the external appearance of the film may be degraded.

### [Light-Shielding Film]

The material configuration of the light-shielding film according to the present disclosure and a method of forming the light-shielding film are described below.

### <Material Configuration>

The material configuration of the light-shielding film according to the present disclosure is described below.

### (Photosensitive Resin Material)

The photosensitive resin material in the light-shielding film according to the present disclosure is described. The same material as that described in the above-mentioned section [Light-shielding Paint] is used as the photosensitive resin material. The content of the photosensitive resin material in the light-shielding film according to the present disclosure is preferably 5 vol % or more and 97 vol % or less, more preferably 30 vol % or more and 80 vol % or less. When the content of the photosensitive resin material in the light-shielding film according to the present disclosure is less than 5 vol %, the light-shielding film becomes excessively hard, and film cracking may occur. When the content of the photosensitive resin material in the light-shielding film according to the present disclosure is more than 97 vol %, it may become difficult to increase the refractive index of the film.

### (Colorant)

The colorant is described. The same colorant as that described in the above-mentioned section [Light-shielding Paint] is used as the colorant.

The content of the colorant is preferably 1 vol % or more and 30 vol % or less, more preferably 2 vol % or more and 20 vol % or less. When the content of the colorant in the light-shielding film according to the present disclosure is less than 1 vol %, the light having entered the film cannot be fully absorbed, and the optical characteristics may be degraded. In addition, when the content of the colorant in the light-shielding film according to the present disclosure is more than 30 vol %, the light-shielding film may not be cured with UV light.

The light-shielding film according to the present disclosure has an optical density (ODt) of preferably 0.14 μm⁻¹ or more and 0.53 μm⁻¹ or less, more preferably 0.2 μm⁻¹ or more and 0.5 μm⁻¹ or less. When the ODt is less than 0.14 μm⁻¹, incident light cannot be fully absorbed, and the optical characteristics may be degraded. When the ODt is more than 0.53 μm⁻¹, a curing failure may occur at the time of irradiation with UV light.

### (Inorganic Particles)

The inorganic particles in the light-shielding film according to the present disclosure are described. The same inorganic particles as those described in the above-mentioned section [Light-shielding Paint] are used as the inorganic particles.

The content of the inorganic particles in the light-shielding film according to the present disclosure is preferably 2 vol % or more and 70 vol % or less, more preferably in a range of 3 vol % or more and 40 vol % or less. When the content of the inorganic particles in the light-shielding film according to the present disclosure is less than 2 vol %, the refractive index of the light-shielding film is not increased significantly, and the internal reflection preventing performance may be degraded. In addition, when the content of the inorganic particles in the light-shielding film according to the present disclosure is more than 70 vol %, the thermal shock resistance may be degraded.

### (Photopolymerization Initiator)

The photopolymerization initiator in the light-shielding film according to the present disclosure is described. The same photopolymerization initiator as that described in the above-mentioned section [Light-shielding Paint] is used as the photopolymerization initiator.

The content of the photopolymerization initiator in the light-shielding film according to the present disclosure is preferably 0.1 vol % or more and 15 vol % or less, more preferably in a range of 0.5 vol % or more and 10 vol % or less. When the content of the photopolymerization initiator in the light-shielding film according to the present disclosure is less than 0.1 vol %, the reaction does not proceed at the time of irradiation with UV light, and the cleaning resistance may be degraded. In addition, when the content of the photopolymerization initiator in the light-shielding film according to the present disclosure is more than 15 vol %, the photopolymerization initiator may seep from the film to alter the glass component.

### (Compound Having Thiol Group)

The compound having a thiol group in the light-shielding film according to the present disclosure is described.

The content of the compound having a thiol group in the light-shielding film according to the present disclosure is preferably 0.5 vol % or more and 40 vol % or less, more preferably in a range of 1 vol % or more and 10 vol % or less. When the content of the compound having a thiol group is less than 0.5 vol %, the reaction does not proceed at the time of irradiation with UV light, and the cleaning resistance may be degraded. In addition, when the content of the compound having a thiol group is more than 40 vol %, the film becomes excessively flexible, and the water resistance may be degraded.

### (Other Curing Accelerator)

The other curing accelerator is described. The same curing accelerator as that described in the above-mentioned section [Light-shielding Paint] is used as the other curing accelerator.

The content of the curing accelerator in the light-shielding film according to the present disclosure is preferably 0.1 vol % or more and 15 vol % or less, more preferably in a range of 0.5 vol % or more and 5 vol % or less. When the content of the curing accelerator is less than 0.1 vol %, the reaction does not proceed at the time of irradiation with UV light, and the cleaning resistance may be degraded. In addition, when the content of the curing accelerator is more than 15 vol %, the curing accelerator may seep from the film to alter the glass component.

### (Other Additives)

The light-shielding film according to the present disclosure may contain any other additive. Examples thereof include a curing agent, a dispersant, an antifoaming agent, a thixotropy-imparting agent, a leveling agent, a matting agent, a preservative, an antibacterial agent, a fungicide, a UV absorber, an antioxidant, a coupling agent, and inorganic particles and organic fine particles for adjusting the color tone other than those described above. The additive is added to the extent that the characteristics are not degraded. Examples of the curing agent include an amine-based curing agent and an isocyanate-based curing agent.

### (Ratio of Curing Reaction Rates of Light-Shielding Film)

Of the lenses that have been produced in recent years, cemented lenses are increasing in addition to non-cemented lenses. Along with the thinning of a bonded portion and a lens edge surface, and the increase in manufacture of soft glass, when a light-shielding film is formed on an outer peripheral portion of the lens, a stress tends to be applied to the lens. In addition, those lenses are often used under a situation subjected to a large thermal shock, such as a cold region or a region under scorching heat. Thus, there is a demand for reducing the stress on the lens caused by the light-shielding film. The temperature in a cold region is assumed to be about −30° C.

In addition, in order to remove the adhesion of extremely fine contaminants to the lens that occurs in the production process of the lens, it is required that the lens be ultrasonically cleaned a plurality of times after the light-shielding film is formed. The ultrasonic cleaning is performed at a normal temperature of about 20° C. It is required that no peeling of the light-shielding film due to ultrasonic vibrations occur at the interface with the lens at the time of cleaning. In addition, in order to improve the production efficiency of the lens, it is required to perform cleaning immediately after forming the light-shielding film and proceed to the next step. Thus, the resistance to ultrasonic cleaning is required also immediately after curing.

Based on the foregoing, in the light-shielding film according to the present disclosure, the curing reaction rate of the first surface on the base material side is lower than that of the second surface on a side opposite to the first surface. When the curing reaction rates of the first surface and the second surface are the same, it is difficult to simultaneously improve the cleaning resistance immediately after curing and the thermal shock resistance. In addition, when the curing reaction rate of the first surface on the base material side is higher than that of the second surface on the side opposite to the first surface, both the thermal shock resistance and the cleaning resistance immediately after curing are degraded.

An absorbance of the first surface at 1,407 cm⁻¹ measured by Fourier transform infrared spectroscopy (FT-IR) is represented by A1, and an average value of absorbances thereof in a range of from 700 cm⁻¹ to 4,000 cm⁻¹ is represented by A_{avg} 1. In addition, an absorbance of the second surface at 1,407 cm⁻¹ measured by the Fourier transform infrared spectroscopy is represented by A2, and an average value of absorbances thereof in a range of from 700 cm⁻¹ to 4,000 cm⁻¹ is represented by A_{avg}2. In this case, a ratio of the curing reaction rates of the first surface and the second surface may be calculated from a height of an absorbance A measured by the FT-IR and by the following equation (2).

$$R = ( A 2 / {A}_{avg} 2 ) / ( A 1 / {A}_{avg} 1 ) \qquad ( 2 )$$

The value of the R (ratio of curing reaction rates) determined by the equation (2) is preferably 0.1 or more and 0.99 or less. In addition, the value of the R (ratio of curing reaction rates) determined by the equation (2) is more preferably 0.3 or more and 0.99 or less, still more preferably 0.5 or more and 0.99 or less, most preferably 0.6 or more and 0.99 or less. When the ratio of curing reaction rates is less than 0.1, curing becomes insufficient, and the cleaning resistance may be degraded. In addition, when the ratio of curing reaction rates is more than 0.99, the thermal shock resistance may be degraded.

### (Ratio of Elastic Moduli of Light-Shielding Film)

For the same reason as that for the curing reaction rate of the light-shielding film, regarding the ratio of elastic moduli of the light-shielding film according to the present disclosure, it is preferred that the elastic modulus of the first surface on the base material side be lower than that of the second surface on the side opposite to the first surface. When the elastic moduli of the first surface and the second surface are the same, it is difficult to simultaneously improve the cleaning resistance immediately after curing and the thermal shock resistance. In addition, when the elastic modulus of the first surface on the base material side is higher than that of the second surface on the side opposite to the first surface, both the thermal shock resistance and the cleaning resistance immediately after curing are degraded. The elastic modulus may be measured with a nanoindenter, and the ratio of elastic moduli is represented by the following equation (3).

$$Ratio of elastic moduli = ( elastic modulus of first surface ) / ( elastic modulus of second surface ) \qquad ( 3 )$$

The ratio of elastic moduli of the light-shielding film according to the present disclosure is preferably 0.1 or more and 0.99 or less. When the elastic moduli of the first surface and the second surface are the same, it is difficult to simultaneously improve the cleaning resistance immediately after curing and the thermal shock resistance. In addition, when the elastic modulus of the first surface on the base material side is higher than that of the second surface on the side opposite to the first surface, both the thermal shock resistance and the cleaning resistance immediately after curing are degraded.

In addition, the ratio of the elastic moduli of the first surface and the second surface is preferably 0.01 or more and 0.99 or less, more preferably 0.1 or more and 0.99 or less. When the ratio of the elastic moduli is less than 0.01, curing becomes insufficient, and the cleaning resistance may be degraded. In addition, when the ratio of the elastic moduli is more than 0.99, the thermal shock resistance may be degraded.

In addition, from the viewpoint of the thermal shock resistance of the light-shielding film assumed to be used in a cold region, the elastic modulus at −30° C. is preferably 2,500 MPa or more and 6,000 MPa or less, more preferably 3,000 MPa or more and 4,900 MPa or less. When the clastic modulus of the light-shielding film at −30° C. is less than 2,500 MPa, the clastic modulus at normal temperature is also reduced, and hence the cleaning resistance may be degraded. When a resin ratio of the light-shielding film is set to 87 vol % or more and 95 vol % or less, the clastic modulus can be set within a preferred range. When the elastic modulus of the light-shielding film at −30° C. is more than 6,000 MPa, the lens may be cracked in a thermal shock test.

In addition, assuming that cleaning is performed in the vicinity of a normal temperature of 20° C., the elastic modulus of the light-shielding film at 20° C. is preferably 200 MPa or more and 4,000 MPa or less, more preferably 1,000 MPa or more and 2,600 MPa or less. When the elastic modulus of the light-shielding film at 20° C. is less than 200 MPa, the cleaning resistance may be degraded. In addition, when the clastic modulus of the light-shielding film at 20° C. is more than 4,000 MPa, the elastic modulus thereof at −30° C. is also increased, and hence the lens may be cracked in a thermal shock test.

In addition, it is preferred that the elastic modulus of the light-shielding film be equal to or more than that of the third optical element from the viewpoint of improving the thermal shock resistance.

### <Method of Forming Light-Shielding Film>

Regarding the thickness of the light-shielding film according to the present disclosure, the average thickness of the entire coating film is preferably 2 μm or more and 200 μm or less, more preferably 3 μm or more and 180 μm or less, still more preferably 5 μm or more and 20 μm or less. The light-shielding film according to the present disclosure is also formed in a chamfered portion, and hence liquid pooling of the light-shielding film is liable to occur. Thus, the light-shielding film may have a variation in thickness. It is preferred that each of the edge surface of the first optical element and the edge surface of the second optical element be formed with an average thickness of 0.1 μm or more and 200 μm or less, preferably 1 μm or more and 150 μm or less, more preferably 2 μm or more and 30 μm or less. When the thickness of each of the edge surface of the first optical element and the edge surface of the second optical element is less than 0.1 μm, the optical performance may be degraded. When the thickness of each of the edge surface of the first optical element and the edge surface of the second optical element is more than 200 μm, the fitting accuracy with the lens barrel may be degraded.

It is preferred that the thickness of the light-shielding film formed in contact with the edge surface of the third optical element be larger by 1 μm or more than the thickness of the light-shielding film formed in contact with surfaces of portions other than the chamfered portion on the edge surface of the first optical element and/or the edge surface of the second optical element.

In addition, the thickness of the light-shielding film in the chamfered portion is preferably 2 μm or more and 200 μm or less, more preferably 4 μm or more and 100 μm or less. When the thickness of the light-shielding film in the chamfered portion is less than 2 μm, light leakage may occur in the light-shielding film, with the result that the light-shielding performance may be degraded. When the thickness of the light-shielding film in the chamfered portion is more than 200 μm, the stress on the lens is increased, and lens cracking may occur when a thermal shock is applied.

Any coating method and curing method may be used for the light-shielding paint to be used in the present disclosure as long as the light-shielding paint can be uniformly applied. Examples of the method of applying the light-shielding paint to be used in the present disclosure include brush coating, spray coating, dip coating, spin coating, transfer, and inkjet. In addition, the light-shielding film may be applied by single-layer coating or multilayer coating. In addition, the glass surface may be subjected to dry surface treatment with UV ozone, plasma, excimer, or the like, or to wet surface treatment with a coupling agent or the like.

In addition, UV curing is preferred as a method of curing the light-shielding film according to the present disclosure. The UV curing involves no heating, and hence the stress on the optical device or the light-shielding film is hardly accumulated. Any device may be used as a device for performing the UV curing as long as a photosensitive resin material can be cured. Examples thereof include a high-pressure mercury lamp, a xenon lamp, and an LED. In addition, the irradiation with UV light may be a spot irradiation type, an area irradiation type, a line irradiation type, or a combination thereof. In addition, regarding the direction from which UV light is applied, the UV light may be applied from any direction with respect to the surface, and the UV light may be applied from directly above or diagonally. The distance between the light-shielding film and the distal end of a UV irradiator is preferably 1 mm or more and 50 cm or less, more preferably 5 mm or more and 10 cm or less. When the distance is less than 1 mm, the light-shielding film and the UV irradiator may be brought into contact with each other. In addition, when the distance is more than 50 cm, the UV irradiation intensity may become insufficient. The UV irradiation intensity is preferably 10 mW/cm² or more and 1,000 mW/cm² or less, more preferably 50 mW/cm² or more and 500 mW/cm² or less. When the UV irradiation intensity is less than 10 mW/cm², the curing time may become excessively long. In addition, when the UV irradiation intensity is more than 1,000 mW/cm², the light-shielding film may be heated to accumulate a stress. In addition, the UV irradiation time is preferably 1 second or more and 10 minutes or less, more preferably 20 seconds or more and 5 minutes or less. When the UV irradiation time is less than 1 second, curing may become insufficient. In addition, when the UV irradiation time is more than 10 minutes, the curing time may become too long to be considered as short time.

Thermosetting or moisture curing may be used together with the UV curing. When the thermosetting is used together with UV curing, curing with a heating furnace or a heater, or infrared heating may be employed. The curing temperature is preferably from 0° C. to 100° C., more preferably from 23° C. to 80° C. When the curing temperature is less than 0° C., a curing failure may occur. In addition, when the curing temperature is more than 100° C., a stress on the optical device or the light-shielding film is increased, and the thermal shock resistance may be degraded.

### EXAMPLES

Exemplary Examples in the present disclosure are described below.

Various evaluations, preparation of a light-shielding paint, and production of a light-shielding film in each of Examples 1 to 18 were performed by the following methods.

### <Evaluation Method>

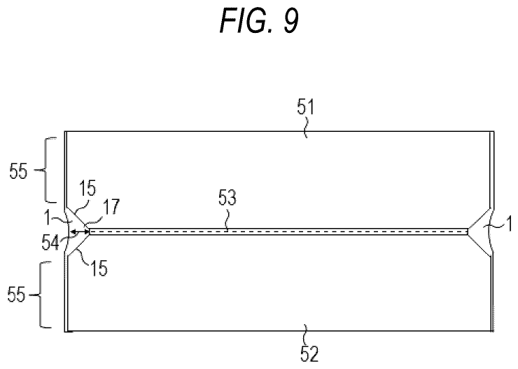

A schematic sectional view of a test piece to be used for evaluating a ratio of curing reaction rates, a ratio of elastic moduli, thermal shock resistance, and cleaning resistance is illustrated in FIG. 9. As illustrated in FIG. 9, the test piece to be used for evaluating a ratio of curing reaction rates included: a glass member in which two circular glasses (i.e., a first monitor glass 51 and a second monitor glass 52) each including the chamfered portion 15 are bonded to each other with an adhesive 53; and the light-shielding film 1 formed on an outer peripheral surface of the glass member. The first monitor glass and the second monitor glass each having a thickness of 5 mm and an outer diameter of 40 mm were used. The outer peripheral portion of each of the first monitor glass 51 and the second monitor glass 52 was subjected to a #1200 grit ground finish. In addition, the outer periphery of a cemented portion of the first monitor glass 51 and the second monitor glass 52 was connected to the chamfered portions 15 each having a length of 0.3 mm. In addition, in each of Examples 1 to 18, a light-shielding paint was applied to the outer peripheral surface of the glass member with a dispenser so that a maximum thickness 54 of the light-shielding film 1 in the groove was 40 μm (5 μm in Example 11) and the average thickness of the light-shielding film 1 in each of flat portions 55 was 5 μm, followed by natural drying for 1 hour. The dried test piece was cured under the respective conditions described in Examples 1 to 18. The minimum thickness of the light-shielding film 1 in each of the flat portions 55 was 1 μm (5 μm in Example 11).

### <Method of Measuring Ratio of Curing Reaction Rates>

FT-IR was used for measuring a ratio of curing reaction rates. The sample produced for the measurement of a reaction rate was set in an FT-IR spectrometer (Spectrum Two+, manufactured by PerkinElmer Japan G.K.), and an absorbance A in a range of from 700 cm⁻¹ to 4,000 cm⁻¹ was measured by an attenuated total reflection (ATR) method. The measurement of the first surface 17 and the second surface 18 of the light-shielding film 1 was performed. The first surface 17 was measured by peeling off the coating film with a cutter after curing the light-shielding film and pressing the back surface of the peeled film against a sample mounting surface of the spectrometer. The second surface 18 was measured by peeling off the light-shielding film 1 and pressing the surface of the peeled film against the sample mounting surface of the spectrometer. The ratio of curing reaction rates was calculated from the obtained results by the above-mentioned equation (2).

### <Method of Measuring Ratio of Elastic Moduli>

For the measurement of a ratio of elastic moduli, the test piece illustrated in FIG. 9 was used in the same manner as in the measurement of a ratio of curing reaction rates. In addition, a nanoindenter was used for measuring the elastic modulus. The test piece including the light-shielding film 1 formed on the glass member was naturally dried for 1 hour and then cured under the respective conditions described in Examples 1 to 18 in the same manner as in the measurement of a ratio of curing reaction rates. The sample produced for the measurement of a ratio of elastic moduli was set in a nanoindenter (Nano Indenter G200, manufactured by Toyo Corporation), and the elastic moduli of the first surface 17 and second surface 18 of the light-shielding film 1 accumulated in the groove formed by the chamfered portions 15 and the edge surface of the adhesive 53 were measured. The elastic modulus of the first surface 17 was evaluated by grinding and shaving off the coating film to a thickness of 0.5 μm, and measuring the elastic modulus from the surface of the coating film adjusted to a thickness of 0.5 μm to a depth of 50 nm. In addition, the clastic modulus of the second surface 18 was evaluated by measuring the clastic modulus from the surface of the coating film to a depth of 50 nm.

### <Method of Measuring Internal Reflectance>

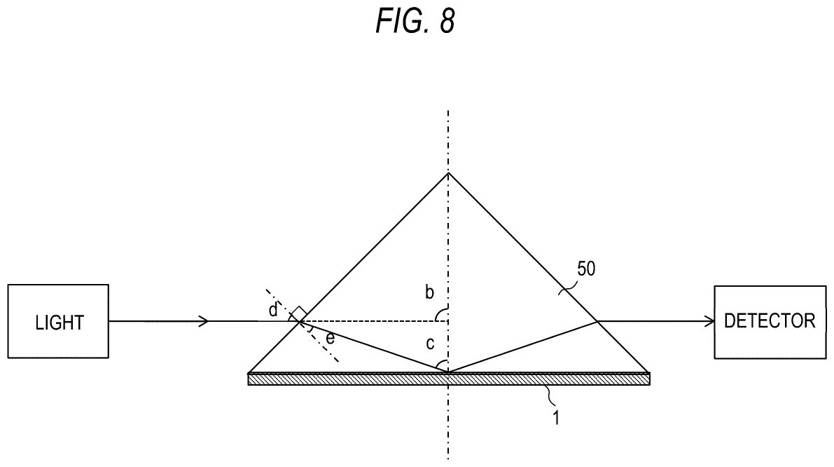

FIG. 8 is a schematic view for illustrating a method of measuring an internal reflectance. The internal reflectance was measured with a spectrophotometer (U-4100, manufactured by Hitachi High-Tech Corporation) as illustrated in FIG. 8. A triangular prism 50 was used as a sample for the measurement. The triangular prism 50 has a shape including two sides forming a right angle and each having a length of 30 mm, has a thickness of 10 mm, and is made of S-LAH53 (n_{d}=1.8, manufactured by Ohara Inc.).

A method of measuring the internal reflectance with an incident angle “b” of 90° with respect to the triangular prism 50 is illustrated in FIG. 8. Light emitted from the spectrophotometer enters the triangular prism 50 at an incident angle “b” of 90°. In this case, refraction of light occurs based on the difference between the refractive index of air and the refractive index of the triangular prism 50. An incident angle “c” after the refraction is 68.13°. An angle “e” after the refraction with respect to an incident angle “d” was calculated by the following calculation equation (4). In addition, the incident angle “c” was calculated from the angle “e” after the refraction.

$$n = sin d / sin e \qquad ( 4 )$$

Next, the light refracted by the triangular prism 50 strikes a bottom surface of the triangular prism 50, is reflected therefrom, and exits the triangular prism 50. The intensity of this reflected light in a visible light region of a wavelength of from 400 nm to 700 nm was detected with a detector. The background was measured by using, as a sample, the triangular prism 50 having three mirror-finished surfaces of the bottom surface, an incident surface, and a reflection surface and having nothing applied to the bottom surface. The internal reflectance was measured by using the triangular prism 50 having three mirror-finished surfaces of the bottom surface, the incident surface, and the reflection surface and having a film formed on the bottom surface.

In addition, the internal reflectance was obtained by measuring the internal reflection of visible light at a wavelength of from 400 nm to 700 nm at intervals of 1 nm, and the average value of the results was determined. The internal reflectance was evaluated based on the following criteria. “A” indicates an extremely excellent film with an internal reflectance of less than 40%. “B” indicates an excellent film with an internal reflectance of 40% or more and less than 50%. “C” indicates a film with an internal reflectance of 50% or more but less than 60%, which is slightly poor in internal reflection but has no practical problems. “D” indicates a film with an internal reflectance of 60% or more, which is poor in optical characteristics.
A: The internal reflectance was less than 40%.
B: The internal reflectance was 40% or more and less than 50%.
C: The internal reflectance was 50% or more and less than 60%.
D: The internal reflectance was 60% or more.

### <Method of Evaluating Thermal Shock Resistance>

For the evaluation of the thermal shock resistance, the test piece illustrated in FIG. 9 was used in the same manner as in the measurement of the ratio of curing reaction rates. A light-shielding paint was applied to the outer peripheral surface of the glass member with a dispenser so that the maximum thickness 54 of the light-shielding film 1 in the groove was 40 μm (5 μm in Example 11) and the average thickness of the light-shielding film 1 in each of the flat portions 55 was 5 μm. In addition, the test piece having the light-shielding film 1 formed thereon was naturally dried for 1 hour and then cured under the respective conditions described in Examples 1 to 18. The produced test piece was left under an environment at −50° C. for 30 minutes and then under an environment at 60° C. for 30 minutes. This operation was defined as one cycle and the cycle was repeated 10 times to apply thermal shock. The thermal shock resistance was evaluated based on the following criteria. “A” indicates an optical device that had no practical problems in thermal shock resistance. “B” indicates an optical device in which a white line having a length of less than 0.5 mm was observed on a boundary surface between the light-shielding film and the chamfered portions, and a slight change was observed in external appearance, which were within ranges causing no practical problems. “C” indicates an optical device in which a white line having a length of 0.5 mm or more and less than 1 mm was observed on the boundary surface between the light-shielding film and the chamfered portions, and a change was observed in external appearance, which were within ranges causing no practical problems. “D” indicates an optical device in which an external appearance defect of a length of 1 mm or more was observed on the boundary surface between the light-shielding film and the chamfered portions, and glass cracking was observed, which means problems in thermal shock resistance.
A: No change was observed in the light-shielding film and the glass.
B: A slight change was observed in the light-shielding film within a range causing no problems.
C: A change was observed in the light-shielding film within a range causing no problems.
D: An external appearance defect was observed in the light-shielding film, and glass cracking was observed.

### (Method of Evaluating Cleaning Resistance)

For the evaluation of the cleaning resistance, a test piece formed by bonding the first monitor glass 51 and the second monitor glass 52 illustrated in FIG. 9 to each other with the adhesive 53, and forming the light-shielding film 1 on the outer peripheral surface thereof under the respective conditions of Examples 1 to 18 was used in the same manner as in the evaluation of the ratio of curing reaction rates.

The produced test piece was placed in water and subjected to ultrasonic cleaning for 5 minutes, followed by drying. The ultrasonic cleaning was performed 5 times. The cleaning resistance was evaluated based on the following criteria. “A” indicates a light-shielding film having no practical problems in which no peeling was observed and no change in color was observed inside the lens. “B” indicates a light-shielding film in which no peeling was observed and a slight change in color was observed inside the lens, which were within ranges causing no practical problems. “C” indicates a light-shielding film in which slight peeling was observed and a slight change in color was observed inside the lens, which were within ranges causing no practical problems. “D” indicates a light-shielding film in which peeling was observed.
A: No peeling was observed and no change in color was observed inside the lens.
B: No peeling was observed and a slight change in color was observed inside the lens, which were within ranges causing no practical problems.
C: Slight peeling was observed and a slight change in color was observed inside the lens, which were within ranges causing no practical problems.
D: Peeling was observed.

### <Method of Measuring Thickness>

The thickness of the optical device was measured by grinding the cut cross-section of a sample for evaluation and measuring the resultant cut cross-section with a field emission scanning electron microscope (ULTRA 55, manufactured by Carl Zeiss AG).

### Example 1

### <Preparation of Light-Shielding Paint>

In Example 1, a light-shielding paint was produced by the following method.

600 g of a photosensitive resin material A, 30 g of a colorant A, 200 g of inorganic particles A, 5 g of a coupling agent A, 30 g of a dispersant A, and 600 g of a solvent A were weighed. All the weighed raw materials were placed in a container and stirred with a stirring blade for 20 minutes to provide a pre-dispersion liquid. The pre-dispersion liquid was stirred with a bead mill for 180 minutes to provide a light-shielding paint main agent of Example 1.

Toluene was used as the solvent A. Rutile-type titanium oxide was used as the inorganic particles A having a d-line refractive index of 2.0 or more and an average particle diameter of 200 nm or less. Carbon black was used as the colorant A. DISPERBYK-2155 (manufactured by BYK Japan KK) was used as the dispersant A. An acrylate-based resin was used as the photosensitive resin material A.

An epoxy-based silane coupling agent (KBM-403, manufactured by Shin-Etsu Silicones) was used as the coupling agent A.

Next, 12 g of a photopolymerization initiator A and 20 g of a compound A having a thiol group were added to 180 g of the light-shielding paint main agent of Example 1 to provide a light-shielding paint of Example 1.

### <Production of Light-Shielding Film>

In Example 1, a light-shielding film was produced by the following method.

The resultant light-shielding paint was applied to glass or a lens to a predetermined thickness and dried at room temperature for 10 minutes. After the film was dried, the film was irradiated with UV light at an intensity of 200 mW/cm² with a UV irradiator EXECURE 4000-D (manufactured by HOYA Corporation) for 5 minutes to provide a film of Example 1.

S-FPL53 (manufactured by Ohara Inc., linear expansion coefficient: 14.5 ppm) was used as a first monitor glass.

Quartz S-FPL53 (manufactured by Ohara Inc., linear expansion coefficient: 0.5 ppm) was used as a second monitor glass.

### <Production of Sample for Evaluating Ratio of Curing Reaction Rates, Ratio of Elastic Moduli, Thermal Shock Resistance, and Cleaning Resistance>

For the production of a sample for evaluating a ratio of curing reaction rates, a ratio of elastic moduli, thermal shock resistance, and cleaning resistance, S-FPL55 (manufactured by Ohara Inc., linear expansion coefficient: 13.6 ppm) was used as a first monitor glass. The first monitor glass was processed so that the diameter of an optical device was 65 mm, the length of a chamfered portion of a first optical element was 0.3 mm, and the radius of curvature of a rounded portion was 0.3 mm. In addition, quartz S-FPL53 (manufactured by Ohara Inc., linear expansion coefficient: 0.5 ppm) was used as a second monitor glass. The second monitor glass was processed so that the diameter of an optical device was 65 mm, the length of a chamfered portion of a second optical element was 0.3 mm, and the radius of curvature of a rounded portion was 0.3 mm. OP-1030M (manufactured by Denka Company Limited) was used as an adhesive A, and curing was performed with UV light.

### Examples 2 to 18

In each of Examples 2 to 18, a light-shielding film was produced in the same manner as in Example 1 except that the materials and conditions in Tables 1-1, 1-2, 2-1, 2-2, 3-1, 3-2 and 4 were used.

The same colorant, inorganic particles, coupling agent, dispersant, and solvent were used in all Examples and Comparative Examples.

M-240 (manufactured by Toagosei Co., Ltd.) was used as a photosensitive resin material B. CELLOXIDE 2021P (manufactured by Daicel Chemical Industries, Ltd.) was used as a photosensitive resin material C. WPI-113 (manufactured by FUJIFILM Corporation) was used as a photopolymerization initiator B. 1-Docosanethiol (manufactured by Tokyo Chemical Industry Co., Ltd.) was used as a compound B having a thiol group. Karenz MT PEI (manufactured by Resonac Corporation) was used as a compound C having a thiol group. Nikkacure TG-10 (manufactured by Nippon Chemical Industrial Co., Ltd.) was used as a curing accelerator A.

A mixture of 100 g of OP-1505 (manufactured by Denka Company Limited), 150 g of Xylene Resin Y-50 (manufactured by Fudow Co., Ltd.), and 1 g of the photopolymerization initiator A was used as an adhesive B. 10 g of AEROSIL R972 (manufactured by Nippon Aerosil Co., Ltd.) was mixed with 100 g of OP-3010P (manufactured by Denka Company Limited) to be used as an adhesive C. 1 g of the photopolymerization initiator A was mixed with 100 g of ACRYDIC WFU-580 (manufactured by DIC Corporation), and the mixture was used as an adhesive D. 30 g of AEROSIL R972 (manufactured by Nippon Aerosil Co., Ltd.) and 1 g of the photopolymerization initiator A were mixed with 100 g of ACRYDIC WFU-580, and the mixture was used as an adhesive E.

TABLE 1-1

| | | | Example 1 | Example 2 | Example 3 |
|---|---|---|---|---|---|
| Light- | Photosensitive resin | Material | Photosensitive resin | Photosensitive resin | Photosensitive resin |
| shielding | material | | material A | material A | material A |
| paint | | Addition amount (g) | 600 | 600 | 600 |
| | Colorant | Material | Colorant A | Colorant A | Colorant A |
| | | Addition amount (g) | 30 | 30 | 30 |
| | Inorganic particles | Material | Inorganic particles A | Inorganic particles A | Inorganic particles A |
| | | Addition amount (g) | 200 | 200 | 200 |
| | Dispersant | Material | Dispersant A | Dispersant A | Dispersant A |
| | | Addition amount (g) | 30 | 30 | 30 |
| | Coupling agent | Material | Coupling agent A | Coupling agent A | Coupling agent A |
| | | Addition amount (g) | 5 | 5 | 5 |
| | Photopolymerization | Material | Photopolymerization | Photopolymerization | Photopolymerization |
| | initiator | | initiator A | initiator A | initiator A |
| | | Addition amount (g) | 12 | 12 | 12 |
| | Compound having | Material | Compound A having | Compound A having | Compound A having |
| | thiol group | | thiol group | thiol group | thiol group |
| | | Addition amount (g) | 20 | 20 | 20 |
| | Curing accelerator | Material | — | Curing accelerator A | — |
| | | Addition amount (g) | — | 12 | — |
| | Curing agent | Material | — | — | — |
| | | Addition amount (g) | — | — | — |
| Light- | UV curing | Curing time (sec) | 300 | 300 | 300 |
| shielding | | Irradiation direction | Surface | Surface | Surface |
| film | Thermosetting | Curing time (min) | — | — | — |
| | Thickness (μm) | Maximum thickness | 40 | 40 | 40 |
| | | Minimum thickness | 1 | 1 | 1 |
| | | Average thickness | 5 | 5 | 5 |
| | Optical density | 0.14 to 0.53 | 0.3 | 0.3 | 0.3 |
| | (ODt)/μm⁻¹ | | | | |
| | Curing reaction rate | First portion | 1.059 | 0.996 | 1.053 |
| | | Second portion | 0.998 | 0.982 | 0.997 |
| | | Ratio | 0.94 | 0.99 | 0.95 |
| | Elastic modulus | First portion | 700 | 700 | 700 |
| | | Second portion | 2,500 | 2,500 | 2,500 |
| | | Ratio | 0.28 | 0.28 | 0.28 |
| Optical | Third optical element | Material | Adhesive A | Adhesive A | Adhesive B |
| device | | Elastic modulus | 7.8 | 7.8 | 0.1 |
| | | (MPa) | | | |

TABLE 1-2

| | | | Example 4 | Example 5 |
|---|---|---|---|---|
| Light- | Photosensitive resin | Material | Photosensitive resin | Photosensitive resin |
| shielding | material | | material A | material A |
| paint | | Addition amount (g) | 600 | 600 |
| | Colorant | Material | Colorant A | Colorant A |
| | | Addition amount (g) | 30 | 30 |
| | Inorganic particles | Material | Inorganic particles A | Inorganic particles A |
| | | Addition amount (g) | 200 | 200 |
| | Dispersant | Material | Dispersant A | Dispersant A |
| | | Addition amount (g) | 30 | 30 |
| | Coupling agent | Material | Coupling agent A | Coupling agent A |
| | | Addition amount (g) | 5 | 5 |
| | Photopolymerization | Material | Photopolymerization | Photopolymerization |
| | initiator | | initiator A | initiator A |
| | | Addition amount (g) | 12 | 12 |
| | Compound having | Material | Compound A having | Compound A having |
| | thiol group | | thiol group | thiol group |
| | | Addition amount (g) | 20 | 20 |
| | Curing accelerator | Material | — | — |
| | | Addition amount (g) | — | — |
| | Curing agent | Material | — | — |
| | | Addition amount (g) | — | — |
| Light- | UV curing | Curing time (sec) | 300 | 300 |
| shielding | | Irradiation direction | Surface | Surface |
| film | Thermosetting | Curing time (min) | — | — |
| | Thickness (μm) | Maximum thickness | 40 | 40 |
| | | Minimum thickness | 1 | 1 |
| | | Average thickness | 5 | 5 |
| | Optical density | 0.14 to 0.53 | 0.3 | 0.3 |
| | (ODt)/μm⁻¹ | | | |
| | Curing reaction rate | First portion | 1.048 | 1.049 |
| | | Second portion | 0.999 | 0.985 |
| | | Ratio | 0.95 | 0.94 |
| | Elastic modulus | First portion | 700 | 700 |
| | | Second portion | 2,500 | 2,500 |
| | | Ratio | 0.28 | 0.28 |
| Optical | Third optical element | Material | Adhesive C | Adhesive D |
| device | | Elastic modulus | 700 | 2,500 |
| | | (MPa) | | |

TABLE 2-1

| | | | Example 6 | Example 7 | Example 8 |
|---|---|---|---|---|---|
| Light- | Photosensitive resin | Material | Photosensitive resin | Photosensitive resin | Photosensitive resin |
| shielding | material | | material A | material B | material C |
| paint | | Addition amount (g) | 600 | 600 | 600 |
| | Colorant | Material | Colorant A | Colorant A | Colorant A |
| | | Addition amount (g) | 30 | 30 | 30 |
| | Inorganic particles | Material | Inorganic particles A | Inorganic particles | Inorganic particles |
| | | | | A | A |
| | | Addition amount (g) | 200 | 200 | 200 |
| | Dispersant | Material | Dispersant A | Dispersant A | Dispersant A |
| | | Addition amount (g) | 30 | 30 | 30 |
| | Coupling agent | Material | Coupling agent A | Coupling agent A | Coupling agent A |
| | | Addition amount (g) | 5 | 5 | 5 |
| | Photopolymerization | Material | Photopolymerization | Photopolymerization | Photopolymerization |
| | initiator | | initiator A | initiator A | initiator B |
| | | Addition amount (g) | 12 | 12 | 12 |
| | Compound having | Material | Compound A having | Compound A having | Compound A having |
| | thiol group | | thiol group | thiol group | thiol group |
| | | Addition amount (g) | 20 | 20 | 20 |
| | Curing accelerator | Material | — | — | — |
| | | Addition amount (g) | — | — | — |
| | Curing agent | Material | — | — | — |
| | | Addition amount (g) | — | — | — |
| Light- | UV curing | Curing time (sec) | 300 | 300 | 300 |
| shielding | | Irradiation direction | Surface | Surface | Surface |
| film | Thermosetting | Curing time (min) | — | — | — |
| | Thickness (μm) | Maximum thickness | 40 | 40 | 40 |
| | | Minimum thickness | 1 | 1 | 1 |
| | | Average thickness | 5 | 5 | 5 |
| | Optical density | 0.14 to 0.53 | 0.3 | 0.3 | 0.3 |
| | (ODt)/μm⁻¹ | | | | |
| | Curing reaction rate | First portion | 1.056 | 1.058 | 1.054 |
| | | Second portion | 0.991 | 0.998 | 0.994 |
| | | Ratio | 0.94 | 0.94 | 0.94 |
| | Elastic modulus | First portion | 700 | 700 | 700 |
| | | Second portion | 2,500 | 2,500 | 2,500 |
| | | Ratio | 0.28 | 0.28 | 0.28 |
| Optical | Third optical element | Material | Adhesive E | Adhesive A | Adhesive A |
| device | | Elastic modulus | 3,000 | 7.8 | 7.8 |
| | | (MPa) | | | |

TABLE 2-2

| | | | Example 9 | Example 10 |
|---|---|---|---|---|
| Light- | Photosensitive resin | Material | Photosensitive resin | Photosensitive resin |
| shielding | material | | material A | material A |
| paint | | Addition amount (g) | 600 | 600 |
| | Colorant | Material | Colorant A | Colorant A |
| | | Addition amount (g) | 30 | 30 |
| | Inorganic particles | Material | Inorganic particles A | Inorganic particles A |
| | | Addition amount (g) | 200 | 200 |
| | Dispersant | Material | Dispersant A | Dispersant A |
| | | Addition amount (g) | 30 | 30 |
| | Coupling agent | Material | Coupling agent A | Coupling agent A |
| | | Addition amount (g) | 5 | 5 |
| | Photopolymerization | Material | Photopolymerization | Photopolymerization |
| | initiator | | initiator A | initiator A |
| | | Addition amount (g) | 12 | 12 |
| | Compound having | Material | Compound having | Compound having |
| | thiol group | | thiol group B | thiol group C |
| | | Addition amount (g) | 20 | 20 |
| | Curing accelerator | Material | — | — |
| | | Addition amount (g) | — | — |
| | Curing agent | Material | — | — |
| | | Addition amount (g) | — | — |
| Light- | UV curing | Curing time (sec) | 300 | 300 |
| shielding | | Irradiation direction | Surface | Surface |
| film | Thermosetting | Curing time (min) | — | — |
| | Thickness (μm) | Maximum thickness | 40 | 40 |
| | | Minimum thickness | 1 | 1 |
| | | Average thickness | 5 | 5 |
| | Optical density | 0.14 to 0.53 | 0.3 | 0.3 |
| | (ODt)/μm⁻¹ | | | |
| | Curing reaction rate | First portion | 1.059 | 1.055 |
| | | Second portion | 0.998 | 0.993 |
| | | Ratio | 0.94 | 0.94 |
| | Elastic modulus | First portion | 700 | 700 |
| | | Second portion | 2,500 | 2,500 |
| | | Ratio | 0.28 | 0.28 |
| Optical | Third optical element | Material | Adhesive A | Adhesive A |
| device | | Elastic modulus | 7.8 | 7.8 |
| | | (MPa) | | |

TABLE 3-1

| | | | Example 11 | Example 12 | Example 13 |
|---|---|---|---|---|---|
| Light- | Photosensitive resin | Material | Photosensitive resin | Photosensitive resin | Photosensitive resin |
| shielding | material | | material A | material A | material A |
| paint | | Addition amount (g) | 600 | 600 | 600 |
| | Colorant | Material | Colorant A | Colorant A | Colorant A |
| | | Addition amount (g) | 30 | 30 | 30 |
| | Inorganic particles | Material | Inorganic particles A | Inorganic particles A | Inorganic particles A |
| | | Addition amount (g) | 200 | 200 | 200 |
| | Dispersant | Material | Dispersant A | Dispersant A | Dispersant A |
| | | Addition amount (g) | 30 | 30 | 30 |
| | Coupling agent | Material | Coupling agent A | Coupling agent A | Coupling agent A |
| | | Addition amount (g) | 5 | 5 | 5 |
| | Photopolymerization | Material | Photopolymerization | Photopolymerization | Photopolymerization |
| | initiator | | initiator A | initiator A | initiator A |
| | | Addition amount (g) | 12 | 12 | 12 |
| | Compound having | Material | Compound A having | Compound A having | Compound A having |
| | thiol group | | thiol group | thiol group | thiol group |
| | | Addition amount (g) | 20 | 20 | 20 |
| | Curing accelerator | Material | — | — | — |
| | | Addition amount (g) | — | — | — |
| | Curing agent | Material | — | — | — |
| | | Addition amount (g) | — | — | — |
| Light- | UV curing | Curing time (sec) | 300 | 120 | 30 |
| shielding | | Irradiation direction | Surface | Surface | Surface |
| film | Thermosetting | Curing time (min) | — | — | — |
| | Thickness (μm) | Maximum thickness | 5 | 40 | 40 |
| | | Minimum thickness | 5 | 1 | 1 |
| | | Average thickness | 5 | 5 | 5 |
| | Optical density | 0.14 to 0.53 | 0.3 | 0.3 | 0.3 |
| | (ODt)/μm⁻¹ | | | | |
| | Curing reaction rate | First portion | 1.051 | 1.632 | 3.22 |
| | | Second portion | 0.986 | 0.975 | 0.99 |
| | | Ratio | 0.94 | 0.6 | 0.31 |
| | Elastic modulus | First portion | 700 | 400 | 200 |
| | | Second portion | 2,500 | 2,400 | 2,300 |
| | | Ratio | 0.28 | 0.166667 | 0.086957 |
| Optical | Third optical element | Material | Adhesive A | Adhesive A | Adhesive A |
| device | | Elastic modulus | 7.8 | 7.8 | 7.8 |
| | | (MPa) | | | |

TABLE 3-2

| | | | Example 14 | Example 15 |
|---|---|---|---|---|
| Light- | Photosensitive resin | Material | Photosensitive resin | Photosensitive resin |
| shielding | material | | material A | material A |
| paint | | Addition amount (g) | 600 | 600 |
| | Colorant | Material | Colorant A | Colorant A |
| | | Addition amount (g) | 30 | 14 |
| | Inorganic particles | Material | Inorganic particles A | Inorganic particles A |
| | | Addition amount (g) | 200 | 200 |
| | Dispersant | Material | Dispersant A | Dispersant A |
| | | Addition amount (g) | 30 | 30 |
| | Coupling agent | Material | Coupling agent A | Coupling agent A |
| | | Addition amount (g) | 5 | 5 |
| | Photopolymerization | Material | Photopolymerization | Photopolymerization |
| | initiator | | initiator A | initiator A |
| | | Addition amount (g) | 12 | 12 |
| | Compound having | Material | Compound A having | Compound A having |
| | thiol group | | thiol group | thiol group |
| | | Addition amount (g) | 20 | 20 |
| | Curing accelerator | Material | — | — |
| | | Addition amount (g) | — | — |
| | Curing agent | Material | — | — |
| | | Addition amount (g) | — | — |
| Light- | UV curing | Curing time (sec) | 20 | 240 |
| shielding | | Irradiation direction | Surface | Surface |
| film | Thermosetting | Curing time (min) | — | — |
| | Thickness (μm) | Maximum thickness | 40 | 40 |
| | | Minimum thickness | 1 | 1 |
| | | Average thickness | 5 | 5 |
| | Optical density | 0.14 to 0.53 | 0.3 | 0.14 |
| | (ODt)/μm⁻¹ | | | |
| | Curing reaction rate | First portion | 3.49 | 1.024 |
| | | Second portion | 0.998 | 0.993 |
| | | Ratio | 0.29 | 0.97 |
| | Elastic modulus | First portion | 50 | 600 |
| | | Second portion | 2,100 | 2,400 |
| | | Ratio | 0.02381 | 0.25 |
| Optical | Third optical element | Material | Adhesive A | Adhesive A |
| device | | Elastic modulus | 7.8 | 7.8 |
| | | (MPa) | | |

TABLE 4

| | | | Example 16 | Example 17 | Example 18 |
|---|---|---|---|---|---|
| Light- | Photosensitive resin | Material | Photosensitive resin | Photosensitive resin | Photosensitive resin |
| shielding | material | | material A | material A | material A |
| paint | | Addition amount (g) | 600 | 600 | 600 |
| | Colorant | Material | Colorant A | Colorant A | Colorant A |
| | | Addition amount (g) | 53 | 12 | 55 |
| | Inorganic particles | Material | Inorganic particles A | Inorganic particles | Inorganic particles A |
| | | | | A | |
| | | Addition amount (g) | 200 | 200 | 200 |
| | Dispersant | Material | Dispersant A | Dispersant A | Dispersant A |
| | | Addition amount (g) | 30 | 30 | 30 |
| | Coupling agent | Material | Coupling agent A | Coupling agent A | Coupling agent A |
| | | Addition amount (g) | 5 | 5 | 5 |
| | Photopolymerization | Material | Photopolymerization | Photopolymerization | Photopolymerization |
| | initiator | | initiator A | initiator A | initiator A |
| | | Addition amount (g) | 12 | 12 | 12 |
| | Compound having | Material | Compound A having | Compound A having | Compound A having |
| | thiol group | | thiol group | thiol group | thiol group |
| | | Addition amount (g) | 20 | 20 | 20 |
| | Curing accelerator | Material | — | — | — |
| | | Addition amount (g) | — | — | — |
| | Curing agent | Material | — | — | — |
| | | Addition amount (g) | — | — | — |
| Light- | UV curing | Curing time (sec) | 240 | 240 | 240 |
| shielding | | Irradiation direction | Surface | Surface | Surface |
| film | Thermosetting | Curing time (min) | — | — | — |
| | Thickness (μm) | Maximum thickness | 40 | 40 | 40 |
| | | Minimum thickness | 1 | 1 | 1 |
| | | Average thickness | 5 | 5 | 5 |
| | Optical density | 0.14 to 0.53 | 0.53 | 0.12 | 0.55 |
| | (ODt)/μm⁻¹ | | | | |
| | Curing reaction rate | First portion | 1.141 | 1.084 | 1.337 |
| | | Second portion | 0.992 | 0.997 | 0.993 |
| | | Ratio | 0.87 | 0.97 | 0.74 |
| | Elastic modulus | First portion | 600 | 600 | 600 |
| | | Second portion | 2,600 | 2,400 | 2,600 |
| | | Ratio | 0.230769 | 0.25 | 0.230769 |
| Optical | Third optical element | Material | Adhesive A | Adhesive A | Adhesive A |
| device | | Elastic modulus | 7.8 | 7.8 | 7.8 |
| | | (MPa) | | | |

### <Evaluation Results>

The results obtained by evaluating the thermal shock resistance, cleaning resistance, internal reflectance, and curing time of each of the light-shielding films of Examples 1 to 18 by the above-mentioned methods are shown in Tables 5 to 8.

As the evaluation results, in the thermal shock resistance test, it is preferred that the optical device have no change or a slight change observed in the light-shielding film, the change falling within a range causing no problems. In addition, in the cleaning resistance test, it is preferred that the optical device have no peeling or slight peeling of the light-shielding film and no change or a slight change in color observed inside the lens, the results falling within ranges causing no problems. In addition, it is preferred that the internal reflectance be less than 60%. In addition, it is preferred that the curing time with UV light be 10 minutes or less.

In Example 1, a light-shielding paint main agent was produced by using the photosensitive resin material A, the colorant A, the inorganic particles A, the coupling agent A, the dispersant A, and the solvent. In addition, a light-shielding paint was produced by mixing the produced light-shielding paint main agent, the photopolymerization initiator A, and the compound A having a thiol group. The light-shielding paint was applied to a test piece for each evaluation to form a light-shielding film, and the thermal shock resistance, cleaning resistance, and internal reflectance of the light-shielding film were evaluated. As shown in Table 5, no change was observed in the thermal shock resistance, and thus the result was satisfactory. In addition, regarding the cleaning resistance, no peeling of the film and no change in color inside the lens were observed. In addition, the internal reflectance was less than 40%, and thus the result was satisfactory. In addition, the curing time was 5 minutes, which was short and satisfactory.

In Example 2, a light-shielding film was produced in the same manner as in Example 1 except that a light-shielding paint including 12 g of the curing accelerator A added was used. As shown in Table 5, no change was observed in the thermal shock resistance, and thus the result was satisfactory. In addition, regarding the cleaning resistance, no peeling of the film and no change in color inside the lens were observed. In addition, the internal reflectance was less than 40%, and thus the result was satisfactory. In addition, the curing time was 5 minutes, which was short and satisfactory.

In Example 3, a light-shielding film was produced in the same manner as in Example 1 except that a material providing a third optical element having an elastic modulus of 0.1 MPa was used. As shown in Table 5, no change was observed in the thermal shock resistance, and thus the result was satisfactory. In addition, regarding the cleaning resistance, no peeling of the film and no change in color inside the lens were observed. In addition, the internal reflectance was less than 40%, and thus the result was satisfactory. In addition, the curing time was 5 minutes, which was short and satisfactory.

In Example 4, a light-shielding film was produced in the same manner as in Example 1 except that a material providing a third optical element having an elastic modulus of 700 MPa was used. As shown in Table 5, a slight change was observed in the light-shielding film regarding the thermal shock resistance, the change falling within a range causing no problems. In addition, regarding the cleaning resistance, no peeling of the film and no change in color inside the lens were observed. In addition, the internal reflectance was less than 40%, and thus the result was satisfactory. In addition, the curing time was 5 minutes, which was short and satisfactory.

In Example 5, a light-shielding film was produced in the same manner as in Example 1 except that a material providing a third optical element having an elastic modulus of 2,500 MPa was used. As shown in Table 5, a change was observed in the light-shielding film regarding the thermal shock resistance, the change falling within a range causing no problems. In addition, regarding the cleaning resistance, no peeling of the film and no change in color inside the lens were observed. In addition, the internal reflectance was less than 40%, and thus the result was satisfactory. In addition, the curing time was 5 minutes, which was short and satisfactory.

In Example 6, a light-shielding film was produced in the same manner as in Example 1 except that a material providing a third optical element having an elastic modulus of 3,000 MPa was used. As shown in Table 6, a change was observed in the light-shielding film regarding the thermal shock resistance, the change falling within a range causing no problems. In addition, regarding the cleaning resistance, no peeling of the film and no change in color inside the lens were observed. In addition, the internal reflectance was less than 40%, and thus the result was satisfactory. In addition, the curing time was 5 minutes, which was short and satisfactory.

In Example 7, a light-shielding film was produced in the same manner as in Example 1 except that a light-shielding paint including the photosensitive resin material B having no hydroxy group added as the photosensitive resin material was used. As shown in Table 6, no change was observed in the thermal shock resistance, and thus the result was satisfactory. In addition, regarding the cleaning resistance, no peeling of the film was observed and a slight change in color inside the lens was observed, the change falling within a range causing no problems. In addition, the internal reflectance was less than 40%, and thus the result was satisfactory. In addition, the curing time was 5 minutes, which was short and satisfactory.

In Example 8, a light-shielding film was produced in the same manner as in Example 1 except that a light-shielding paint including the photosensitive resin material C having an epoxy group used as the photosensitive resin material and the photopolymerization initiator B used as the photopolymerization initiator was used. As shown in Table 6, a slight change was observed in the light-shielding film regarding the thermal shock resistance, the change falling within a range causing no problems. In addition, regarding the cleaning resistance, no peeling of the film and no change in color inside the lens were observed. In addition, the internal reflectance was less than 40%, and thus the result was satisfactory. In addition, the curing time was 5 minutes, which was short and satisfactory.

In Example 9, a light-shielding film was produced in the same manner as in Example 1 except that a light-shielding paint including the compound B having a thiol group that was a monofunctional thiol used as the compound having a thiol group was used. As shown in Table 6, no change was observed in the thermal shock resistance, and thus the result was satisfactory. In addition, regarding the cleaning resistance, no peeling of the film was observed and a slight change in color inside the lens was observed, the change falling within a range causing no problems. In addition, the internal reflectance was less than 40%, and thus the result was satisfactory. In addition, the curing time was 5 minutes, which was short and satisfactory.

In Example 10, a light-shielding film was produced in the same manner as in Example 1 except that a light-shielding paint including the compound C having a thiol group having an ester bond used as the compound having a thiol group was used. As shown in Table 6, no change was observed in the thermal shock resistance, and thus the result was satisfactory. In addition, regarding the cleaning resistance, slight peeling of the film was observed and a slight change in color inside the lens was observed, the results falling within a range causing no problems. In addition, the internal reflectance was less than 40%, and thus the result was satisfactory. In addition, the curing time was 5 minutes, which was short and satisfactory.

In Example 11, a light-shielding film was produced in the same manner as in Example 1 except that a light-shielding film having the difference between the maximum thickness and the minimum thickness adjusted to 1 μm or less was used. As shown in Table 7, no change was observed in the thermal shock resistance, and thus the result was satisfactory. In addition, regarding the cleaning resistance, no peeling of the film and no change in color inside the lens were observed. In addition, the internal reflectance was less than 40%, and thus the result was satisfactory. In addition, the curing time was 5 minutes, which was short and satisfactory.

In Example 12, a light-shielding film was produced in the same manner as in Example 1 except that a light-shielding film using a light-shielding paint cured for 2 minutes to adjust the ratio of curing reaction rates to 0.6 was used. As shown in Table 7, no change was observed in the thermal shock resistance, and thus the result was satisfactory. In addition, regarding the cleaning resistance, no peeling of the film and no change in color inside the lens were observed. In addition, the internal reflectance was less than 40%, and thus the result was satisfactory. In addition, the curing time was 2 minutes, which was short and satisfactory.

In Example 13, a light-shielding film was produced in the same manner as in Example 1 except that a light-shielding film using a light-shielding paint cured for 0.5 minutes to adjust the ratio of curing reaction rates to 0.31 was used. As shown in Table 7, no change was observed in the thermal shock resistance, and thus the result was satisfactory. In addition, regarding the cleaning resistance, no peeling of the film was observed and a slight change in color inside the lens was observed, the change falling within a range causing no problems. In addition, the internal reflectance was less than 40%, and thus the result was satisfactory. In addition, the curing time was 0.5 minutes, which was short and satisfactory.

In Example 14, a light-shielding film was produced in the same manner as in Example 1 except that a light-shielding film using a light-shielding paint cured for 20 seconds to adjust the ratio of curing reaction rates to 0.29 was used. As shown in Table 7, no change was observed in the thermal shock resistance, and thus the result was satisfactory. In addition, regarding the cleaning resistance, no peeling of the film was observed and a slight change in color inside the lens was observed, the change falling within a range causing no problems. In addition, the internal reflectance was less than 40%, and thus the result was satisfactory. In addition, the curing time was 20 seconds, which was short and satisfactory.

In Example 15, a light-shielding film was produced in the same manner as in Example 1 except that a light-shielding paint having the optical density (ODt)/μm⁻¹ adjusted to 0.14 was used. As shown in Table 7, no change was observed in the thermal shock resistance, and thus the result was satisfactory. In addition, regarding the cleaning resistance, no peeling of the film and no change in color inside the lens were observed. In addition, the internal reflectance was 40% or more and less than 50%, the result falling within a range causing no problems. In addition, the curing time was 5 minutes, which was short and satisfactory.

In Example 16, a light-shielding film was produced in the same manner as in Example 1 except that a light-shielding paint having the optical density (ODt)/μm⁻¹ adjusted to 0.53 was used. As shown in Table 8, no change was observed in the thermal shock resistance, and thus the result was satisfactory. In addition, regarding the cleaning resistance, slight peeling of the film was observed and a slight change in color inside the lens was observed, the results falling within ranges causing no problems. In addition, the internal reflectance was less than 40%, and thus the result was satisfactory. In addition, the curing time was 5 minutes, which was short and satisfactory.

In Example 17, a light-shielding film was produced in the same manner as in Example 1 except that a light-shielding paint having the optical density (ODt)/μm⁻¹ adjusted to 0.12 was used. As shown in Table 8, no change was observed in the thermal shock resistance, and thus the result was satisfactory. In addition, regarding the cleaning resistance, no peeling of the film and no change in color inside the lens were observed. In addition, the internal reflectance was 50% or more and less than 60%, the result falling within a range causing no problems. In addition, the curing time was 5 minutes, which was short and satisfactory.

In Example 18, a light-shielding film was produced in the same manner as in Example 1 except that a light-shielding paint having the optical density (ODt)/μm⁻¹ adjusted to 0.55 was used. As shown in Table 8, no change was observed in the thermal shock resistance, and thus the result was satisfactory. In addition, regarding the cleaning resistance, slight peeling of the film was observed and a slight change in color inside the lens was observed, the results falling within ranges causing no problems. In addition, the internal reflectance was less than 40%, and thus the result was satisfactory. In addition, the curing time was 5 minutes, which was short and satisfactory.

TABLE 5

| | | | Example | Example | Example | Example | Example |
|---|---|---|---|---|---|---|---|
| | | | 1 | 2 | 3 | 4 | 5 |
| Evaluation | Cleaning resistance | | A | A | A | A | A |
| results | Thermal shock resistance | | A | A | A | B | C |
| | Optical characteristics | | A | A | A | A | A |
| | Curing | First | 1.059 | 0.996 | 1.053 | 1.048 | 1.049 |
| | reaction | surface | | | | | |
| | rate | Second | 0.998 | 0.982 | 0.997 | 0.999 | 0.985 |
| | | surface | | | | | |
| | | Ratio | 0.94 | 0.99 | 0.95 | 0.95 | 0.94 |

| | | | | | |
|---|---|---|---|---|---|
| Curing time (min) | 5 | 5 | 5 | 5 | 5 |

TABLE 6

| | | | Example | Example | Example | Example | Example |
|---|---|---|---|---|---|---|---|
| | | | 6 | 7 | 8 | 9 | 10 |
| Evaluation | Cleaning resistance | | A | B | A | B | C |
| results | Thermal shock | | C | A | B | A | A |
| | resistance | | | | | | |
| | Optical characteristics | | A | A | A | A | A |
| | Curing | First | 1.056 | 1.058 | 1.054 | 1.059 | 1.055 |
| | reaction | surface | | | | | |
| | rate | Second | 0.991 | 0.998 | 0.994 | 0.998 | 0.993 |
| | | surface | | | | | |
| | | Ratio | 0.94 | 0.94 | 0.94 | 0.94 | 0.94 |

| | | | | | |
|---|---|---|---|---|---|
| Curing time (min) | 5 | 5 | 5 | 5 | 5 |

TABLE 7

| | | | Example | Example | Example | Example | Example |
|---|---|---|---|---|---|---|---|
| | | | 11 | 12 | 13 | 14 | 15 |
| Evaluation | Cleaning resistance | | A | A | B | B | A |
| results | Thermal shock resistance | | A | A | A | A | A |
| | Optical characteristics | | A | A | A | A | B |
| | Curing | First surface | 1.051 | 1.632 | 3.22 | 3.49 | 1.024 |
| | reaction rate | Second | 0.986 | 0.975 | 0.99 | 0.998 | 0.993 |
| | | surface | | | | | |
| | | Ratio | 0.94 | 0.6 | 0.31 | 0.29 | 0.97 |

| | | | | | |
|---|---|---|---|---|---|
| Curing time (min) | 5 | 2 | 0.5 | ⅓ | 5 |

TABLE 8

| | | | Example | Example | Example |
|---|---|---|---|---|---|
| | | | 16 | 17 | 18 |
| Evaluation | Cleaning resistance | | C | A | C |
| results | Thermal shock resistance | | A | A | A |
| | Optical characteristics | | A | C | A |
| | Curing | First surface | 1.141 | 1.084 | 1.337 |
| | reaction | Second surface | 0.992 | 0.997 | 0.993 |
| | rate | Ratio | 0.87 | 0.97 | 0.74 |

| | | | |
|---|---|---|---|
| Curing time (min) | 5 | 5 | 5 |

### Comparative Examples 1 to 3

In each of Comparative Examples 1 to 3, a light-shielding film was produced in the same manner as in Example 1 except that the materials and the conditions in Table 9 were used.

The materials and mixing ratios of the paint and the curing agent of each of Comparative Examples 1 to 3 are shown in Table 9.

The evaluation results of Comparative Examples 1 to 3 each using the paint and the curing agent in Table 9 are shown in Table 10.

In Comparative Example 1, a light-shielding film was produced in the same manner as in Example 1 except that a light-shielding paint including no compound having a thiol group added was used. As shown in Table 10, no change was observed in the thermal shock resistance, and thus the result was satisfactory. However, regarding the cleaning resistance, extensive peeling of the light-shielding film was observed. The internal reflectance was less than 40%, and thus the result was satisfactory. In addition, the curing time was 5 minutes, which was short and satisfactory.

In Comparative Example 2, a light-shielding film was produced in the same manner as in Example 1 except that a light-shielding paint including no compound having a thiol group added and the curing accelerator A added was used. As shown in Table 10, no change was observed in the thermal shock resistance, and thus the result was satisfactory. However, regarding the cleaning resistance, slight peeling of the film was observed. In addition, the internal reflectance was less than 40%, and thus the result was satisfactory. In addition, the curing time was 5 minutes, which was short and satisfactory.

In Comparative Example 3, a light-shielding film was produced in the same manner as in Example 1 except that a light-shielding film cured with UV light applied from the back surface of the film and having a ratio of curing reaction rates of 1.02 was used. As shown in Table 10, an external appearance defect of the film was observed and glass cracking was observed in the thermal shock resistance. However, regarding the cleaning resistance, no change was observed. The internal reflectance was less than 40%, and thus the result was satisfactory. In addition, the curing time was 5 minutes, which was short and satisfactory.

TABLE 9

| | | | Comparative | Comparative | Comparative |
|---|---|---|---|---|---|
| | | | Example 1 | Example 2 | Example 3 |
| Light- | Photosensitive resin | Material | Photosensitive resin | Photosensitive resin | Photosensitive resin |
| shielding | material | | material A | material A | material A |
| paint | | Addition amount (g) | 600 | 600 | 600 |
| | Colorant | Material | Colorant A | Colorant A | Colorant A |
| | | Addition amount (g) | 30 | 30 | 30 |
| | Inorganic fine | Material | Inorganic fine | Inorganic fine | Inorganic fine |
| | particles | | particles A | particles A | particles A |
| | | Addition amount (g) | 200 | 200 | 200 |
| | Dispersant | Material | Dispersant A | Dispersant A | Dispersant A |
| | | Addition amount (g) | 30 | 30 | 30 |
| | Coupling agent | Material | Coupling agent A | Coupling agent A | Coupling agent A |
| | | Addition amount (g) | 5 | 5 | 5 |
| | Photopolymerization | Material | Photopolymerization | Photopolymerization | Photopolymerization |
| | initiator | | initiator A | initiator A | initiator A |
| | | Addition amount (g) | 12 | 12 | 12 |
| | Compound having | Material | — | — | Compound A having |
| | thiol group | | | | thiol group |
| | | Addition amount (g) | — | — | 20 |
| | Curing accelerator | Material | — | Curing accelerator A | — |
| | | Addition amount (g) | — | 12 | — |
| | Curing agent | Material | — | — | — |
| | | Addition amount (g) | — | — | — |
| Light- | UV curing | Curing time (sec) | — | — | 300 |
| shielding | | Irradiation direction | Surface | Surface | Back surface |
| film | Thermosetting | Curing time (min) | — | — | — |
| | Thickness (μm) | Maximum thickness | 40 | 40 | 40 |
| | | Minimum thickness | 1 | 1 | 1 |
| | | Average thickness | 5 | 5 | 5 |
| | Optical density | 0.14 to 0.53 | 0.3 | 0.3 | 0.3 |
| | (ODt)/μm⁻¹ | | | | |
| | Curing reaction rate | First portion | 3.664 | 0.997 | 0.983 |
| | | Second portion | 0.987 | 0.989 | 0.999 |
| | | Ratio | 0.27 | 0.99 | 1.02 |
| | Elastic modulus | First portion | 1,800 | 1,800 | 700 |
| | | Second portion | 1,400 | 1,400 | 2,500 |
| | | Ratio | 1.285714 | 1.285714 | 0.28 |
| Optical | Third optical element | Material | Adhesive A | Adhesive A | Adhesive A |
| device | | Elastic modulus | 7.8 | 7.8 | 7.8 |
| | | (MPa) | | | |

TABLE 10

| | | | Comparative | Comparative | Comparative |
|---|---|---|---|---|---|
| | | | Example 1 | Example 2 | Example 3 |
| Evaluation | Cleaning resistance | | D | D | D |
| results | Thermal shock resistance | | A | A | A |
| | Optical characteristics | | A | A | A |
| | Curing | First surface | 3.664 | 0.997 | 0.983 |
| | reaction | Second surface | 0.987 | 0.989 | 0.999 |
| | rate | Ratio | 0.27 | 0.99 | 1.02 |

| | | | |
|---|---|---|---|
| Curing time (min) | 5 | 5 | 5 |

According to the present disclosure, the optical device excellent in productivity and environmental resistance, and the light-shielding film contributing to the optical device can be provided.

The optical device and the light-shielding film according to the present disclosure can each be used in a lens barrel of, for example, a camera, a video camera, or broadcasting equipment, or in a camera body, a video body, a surveillance camera, an in-vehicle camera, a weather camera, or the like that may be used outdoors.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-174228, filed Oct. 3, 2024, which is hereby incorporated by reference herein in its entirety.

What is claimed is:

1. An optical device comprising:
a first optical element;
a second optical element;
a third optical element configured to cement the first optical element and the second optical element together; and
a light-shielding film continuously formed in contact with an edge surface of the first optical element, an edge surface of the second optical element, and an edge surface of the third optical element,
wherein the light-shielding film is a cured film of a photosensitive resin composition,
wherein the edge surface of the first optical element and/or the edge surface of the second optical element includes a chamfered portion formed in contact with an outer periphery of a cemented surface of the first optical element and/or the second optical element,
wherein a curing reaction rate of the photosensitive resin composition on a first surface of the light-shielding film in contact with the edge surface of the first optical element and the edge surface of the second optical element is lower than a curing reaction rate of the photosensitive resin composition on a second surface thereof on a side opposite to the first surface, and
wherein the light-shielding film contains a compound having a thiol group.

2. The optical device according to claim 1, wherein the light-shielding film has an elastic modulus equal to or more than an elastic modulus of the third optical element.

3. The optical device according to claim 1, wherein the photosensitive resin composition contains a polymerizable compound having an acryloyl group and a hydroxy group.

4. The optical device according to claim 1, wherein the compound having a thiol group is a polyfunctional thiol.

5. The optical device according to claim 1, wherein the compound having a thiol group is free of an ester bond.

6. The optical device according to claim 1, wherein the light-shielding film formed in contact with the edge surface of the third optical element has a thickness larger by 1 μm or more than a thickness of the light-shielding film formed in contact with a surface of a portion other than the chamfered portion in the edge surface of the first optical element and/or the edge surface of the second optical element.

7. The optical device according to claim 1, wherein the light-shielding film has an optical density (ODt) of 0.14 μm⁻¹ or more and 0.53 μm⁻¹ or less.

8. The optical device according to claim 1, wherein, when an absorbance of the first surface at 1,407 cm⁻¹ measured by Fourier transform infrared spectroscopy is represented by A1, and an average value of absorbances thereof in a range of from 700 cm⁻¹ to 4,000 cm⁻¹ is represented by A_{avg} 1, and when an absorbance of the second surface at 1,407 cm⁻¹ measured by the Fourier transform infrared spectroscopy is represented by A2, and an average value of absorbances thereof in a range of from 700 cm⁻¹ to 4,000 cm⁻¹ is represented by A_{avg}2, a value of R determined by the following equation (2) is 0.1 or more and 0.99 or less:
$$R = ( A 2 / {A}_{avg} 2 ) / ( A 1 / {A}_{avg} 1 ) . \qquad ( 2 )$$

9. The optical device according to claim 8, wherein the value of the R is 0.3 or more and 0.99 or less.

10. The optical device according to claim 8, wherein the value of the R is 0.6 or more and 0.99 or less.

11. Optical equipment comprising:
a housing; and
an optical system, which is arranged inside the housing and which includes at least one lens,
wherein the at least one lens is the optical device of claim 1.

12. An image pickup apparatus comprising:
a housing;
an optical system, which is arranged inside the housing and which includes at least one lens; and
an image pickup device configured to receive light that has passed through the optical system,
wherein the at least one lens is the optical device of claim 1.

13. A light-shielding film to be used by being formed on an optical device including a first optical element, a second optical element, and a third optical element configured to cement the first optical element and the second optical element together, an edge surface of the first optical element and/or an edge surface of the second optical element including a chamfered portion formed in contact with an outer periphery of a cemented surface of the first optical element and/or the second optical element, so that the light-shielding film is brought into contact with the edge surface of the first optical element, the edge surface of the second optical element, and the edge surface of the third optical element,
wherein the light-shielding film is a cured film of a photosensitive resin composition,
wherein the light-shielding film has a first surface in contact with the edge surface of the first optical element and the edge surface of the second optical element, and a second surface on a side opposite to the first surface,
wherein a curing reaction rate of the photosensitive resin composition on the first surface is lower than a curing reaction rate of the photosensitive resin composition on the second surface, and
wherein the light-shielding film contains a compound having a thiol group.

14. The light-shielding film according to claim 13, wherein the photosensitive resin composition contains a polymerizable compound having an acryloyl group and a hydroxy group.

15. The light-shielding film according to claim 13, wherein the compound having a thiol group is a polyfunctional thiol.

16. The light-shielding film according to claim 13, wherein the compound having a thiol group is free of an ester bond.

17. The light-shielding film according to claim 13, wherein a portion of the light-shielding film formed in contact with the edge surface of the third optical element has a thickness larger by 1 μm or more than a thickness of a portion of the light-shielding film formed in contact with a surface of a portion other than the chamfered portion in the edge surface of the first optical element and/or the edge surface of the second optical element.

18. The light-shielding film according to claim 13, wherein the light-shielding film has an optical density (ODt) of 0.14 μm⁻¹ or more and 0.53 μm⁻¹ or less.

19. The light-shielding film according to claim 13, wherein, when an absorbance of the first surface at 1,407 cm⁻¹ measured by Fourier transform infrared spectroscopy is represented by A1, and an average value of absorbances thereof in a range of from 700 cm⁻¹ to 4,000 cm⁻¹ is represented by A_{avg}1, and when an absorbance of the second surface at 1,407 cm⁻¹ measured by the Fourier transform infrared spectroscopy is represented by A2, and an average value of absorbances thereof in a range of from 700 cm⁻¹ to 4,000 cm⁻¹ is represented by A_{avg}2, a value of R determined by the following equation (2) is 0.1 or more and 0.99 or less:
$$R = ( A 2 / {A}_{avg} 2 ) / ( A 1 / {A}_{avg} 1 ) . \qquad ( 2 )$$

20. The light-shielding film according to claim 19, wherein the value of the R is 0.3 or more and 0.99 or less.
